(19) United States
(12) Patent Application Publication
(10) Pub. No.: US 2026/0340545 A1
(43) Pub. Date: Oct. 29, 2026

(54) SYSTEM AND METHOD FOR ARTIFICIAL INTELLIGENCE-BASED WORKFORCE TASK FRAMEWORK

(71) Applicant: Pearson Education, Inc., Bloomington, MN (US)

(72) Inventors: Rebecca Mary DEW, Oaklands Park (AU); Mingzhao LI, Seaford (AU); Sandya Gillian BARATHA RAJ, Alexandria (AU); Weidong LIU, Carlingford (AU)

(21) Appl. No.: 19/187,441

(22) Filed: Apr. 23, 2025

(51) Int. Cl. G06Q 10/0633

(52) U.S. Cl. CPC G06Q 10/0633

(57) ABSTRACT

Systems and methods construct and utilize a workforce task framework. The workforce task framework may be constructed by receiving a predefined occupation-task mapping that indicates a relationship between a plurality of raw occupations and a plurality of raw tasks; providing the raw occupations and raw tasks to a first artificial intelligence (AI) model to return a plurality of standardized tasks; providing the plurality of standardized tasks to a second Al model to decompose the plurality of standardized tasks into at least a plurality of actions and a plurality of objects; pairing the plurality of actions with the plurality of objects to form a plurality of task units; generating, from the plurality of task units, a task action hierarchy that indicates a set of actions corresponding to a given standardized task and a task object hierarchy that indicates a focus of the set of actions corresponding to the given standardized task.

### TECHNICAL FIELD

This disclosure relates to the field of systems and methods for use in human-centered computing, and in particular examples to systems and methods configured to implement a comprehensive task framework that leverages artificial intelligence for workforce analysis, planning, and management.

### SUMMARY

According to one aspect of the present disclosure, a method for constructing a workforce task framework is provided. The method comprises receiving, by an electronic processor, a predefined occupation-task mapping, wherein the occupation-task mapping indicates a relationship between a plurality of raw occupations and a plurality of raw tasks; providing, by the electronic processor, the plurality of raw occupations and the plurality of raw tasks to a first artificial intelligence (AI) model, wherein the first AI model is configured to return a plurality of standardized tasks; providing, by the electronic processor, the plurality of standardized tasks to a second AI model, wherein the second AI model is configured to decompose the plurality of standardized tasks into at least a plurality of actions and a plurality of objects; pairing, by the electronic processor, respective ones of the plurality of actions with respective ones of the plurality of objects to form a plurality of task units; providing, by the electronic processor, the plurality of task units to a third AI model, wherein the third AI model is configured to return a plurality of standardized task unit; generating, by the electronic processor from the plurality of standardized task units, a task action hierarchy, wherein the task action hierarchy indicates a set of actions corresponding to a given standardized task and includes a plurality of task action tiers; and generating, by the electronic processor from the plurality of standardized task units, a task object hierarchy, wherein the task object hierarchy indicates a focus of the set of actions corresponding to the given standardized task and includes a plurality of task object tiers.

According to another aspect of the present disclosure, a method for presenting a visualization of a workforce task framework is provided. The method comprises accessing, by an electronic processor, the workforce task framework stored in a database, wherein the workforce task framework includes: a task action hierarchy indicating a respective set of actions corresponding to one of a plurality of tasks, the task action hierarchy including a plurality of task action tiers, and a task object hierarchy indicating a respective focus of the respective set of actions corresponding to the one of the plurality of tasks, the task object hierarchy including a plurality of task object tiers; generating, by the electronic processor, a graphical user interface (GUI) for presenting an occupational data interface to a user; receiving, by the electronic processor, a user selection via the GUI; and presenting, by the electronic processor, a set of graphs via the GUI, the set of graphs visualizing a portion of the workforce task framework based on the user selection.

According to another aspect of the present disclosure, a system for constructing a workforce task framework is provided. The system comprises a memory and a processor operatively connected to the processor, the processor being configured to perform operations comprising receiving, by an electronic processor, a predefined occupation-task mapping, wherein the occupation-task mapping indicates a relationship between a plurality of raw occupations and a plurality of raw tasks; providing, by the electronic processor, the plurality of raw occupations and the plurality of raw tasks to a first artificial intelligence (AI) model, wherein the first AI model is configured to return a plurality of standardized tasks; providing, by the electronic processor, the plurality of standardized tasks to a second AI model, wherein the second AI model is configured to decompose the plurality of standardized tasks into at least a plurality of actions and a plurality of objects; pairing, by the electronic processor, respective ones of the plurality of actions with respective ones of the plurality of objects to form a plurality of task units; providing, by the electronic processor, the plurality of task units to a third AI model, wherein the third AI model is configured to return a plurality of standardized task unit; generating, by the electronic processor from the plurality of standardized task units, a task action hierarchy, wherein the task action hierarchy indicates a set of actions corresponding to a given standardized task and includes a plurality of task action tiers; and generating, by the electronic processor from the plurality of standardized task units, a task object hierarchy, wherein the task object hierarchy indicates a focus of the set of actions corresponding to the given standardized task and includes a plurality of task object tiers.

According to another aspect of the present disclosure, a system for presenting a visualization of a workforce task framework is provided. The system comprises a memory and a processor operatively connected to the processor, the processor being configured to perform operations comprising accessing, by an electronic processor, the workforce task framework stored in a database, wherein the workforce task framework includes: a task action hierarchy indicating a respective set of actions corresponding to one of a plurality of tasks, the task action hierarchy including a plurality of task action tiers, and a task object hierarchy indicating a respective focus of the respective set of actions corresponding to the one of the plurality of tasks, the task object hierarchy including a plurality of task object tiers; generating, by the electronic processor, a graphical user interface (GUI) for presenting an occupational data interface to a user; receiving, by the electronic processor, a user selection via the GUI; and presenting, by the electronic processor, a set of graphs via the GUI, the set of graphs visualizing a portion of the workforce task framework based on the user selection.

According to another aspect of the present disclosure, a non-transitory computer readable medium is provided. The non-transitory computer readable medium stores instructions that, when executed by a processor of a workforce task framework system, causes the system to perform operations comprising receiving, by an electronic processor, a predefined occupation-task mapping, wherein the occupation-task mapping indicates a relationship between a plurality of raw occupations and a plurality of raw tasks; providing, by the electronic processor, the plurality of raw occupations and the plurality of raw tasks to a first artificial intelligence (AI) model, wherein the first AI model is configured to return a plurality of standardized tasks; providing, by the electronic processor, the plurality of standardized tasks to a second AI model, wherein the second AI model is configured to decompose the plurality of standardized tasks into at least a plurality of actions and a plurality of objects; pairing, by the electronic processor, respective ones of the plurality of actions with respective ones of the plurality of objects to form a plurality of task units; providing, by the electronic processor, the plurality of task units to a third AI model, wherein the third AI model is configured to return a plurality of standardized task unit; generating, by the electronic processor from the plurality of standardized task units, a task action hierarchy, wherein the task action hierarchy indicates a set of actions corresponding to a given standardized task and includes a plurality of task action tiers; and generating, by the electronic processor from the plurality of standardized task units, a task object hierarchy, wherein the task object hierarchy indicates a focus of the set of actions corresponding to the given standardized task and includes a plurality of task object tiers.

According to another aspect of the present disclosure, a non-transitory computer readable medium is provided. The non-transitory computer readable medium stores instructions that, when executed by a processor of a workforce task framework system, causes the system to perform operations comprising accessing, by an electronic processor, the workforce task framework stored in a database, wherein the workforce task framework includes: a task action hierarchy indicating a respective set of actions corresponding to one of a plurality of tasks, the task action hierarchy including a plurality of task action tiers, and a task object hierarchy indicating a respective focus of the respective set of actions corresponding to the one of the plurality of tasks, the task object hierarchy including a plurality of task object tiers; generating, by the electronic processor, a graphical user interface (GUI) for presenting an occupational data interface to a user; receiving, by the electronic processor, a user selection via the GUI; and presenting, by the electronic processor, a set of graphs via the GUI, the set of graphs visualizing a portion of the workforce task framework based on the user selection.

The above features and advantages of the present invention will be better understood from the following detailed description taken in conjunction with the accompanying drawings.

### BRIEF DESCRIPTION OF THE DRAWINGS

FIG. 1 is a block diagram illustrating an example of a content delivery network.

FIG. 2 is a block diagram illustrating a computer server and computing environment within a content delivery network.

FIG. 3 is a block diagram illustrating an example of one or more data store servers within a content delivery network.

FIG. 4 is a block diagram illustrating an example of one or more content delivery servers within a content delivery network.

FIG. 5 is a block diagram illustrating an example of physical and logical components of a special-purpose computer device within a content delivery network.

FIG. 6 is a block diagram illustrating one example of a communication network.

FIG. 7 is a block diagram illustrating an example of a process flow within a task framework system.

FIG. 8 is a block diagram illustrating an example of a process flow within a task framework system.

FIG. 9 is a flowchart illustrating one example of a method of constructing a task framework.

FIG. 10A is an image illustrating one example of a GUI presentation.

FIG. 10B is an image illustrating one example of a GUI presentation.

FIG. 10C is an image illustrating one example of a GUI presentation.

FIG. 10D is an image illustrating one example of a GUI presentation.

FIG. 11 is a flowchart illustrating one example of a method of presenting a task framework.

### DETAILED DESCRIPTION

The disclosed technology will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

Workforce analysis and planning are important techniques that permit organizations to make strategic decisions and individuals to navigate a rapidly evolving job market. Effective workforce analysis, planning, and management benefits from a deep understanding of the tasks and skills associated with different roles. In this manner, tasks define the responsibilities of a job role and form the foundation for identifying the skills required. By linking these tasks to broader occupational trends, workforce analysis offers insights for both strategic decisions and personal career growth.

Well-defined tasks specify job requirements and measurable outcomes, such as time, cost, and quality. They serve as the foundation for role design, performance evaluation, and improvement through targeted skills, technologies, or processes. However, accurately defining tasks is inherently complex due to variations across companies, industries, and regions. These challenges are further compounded by evolving job demands driven by technological advancements and market dynamics, making it harder to link tasks to role requirements for effective recruitment and workforce planning.

The Occupational Information Network (O*NET), maintained by the U.S. Department of Labor, is a standard for representing tasks according to comparative methodologies. However, O*NET relies on surveys to gather task information, a process that is both time-consuming and costly. The task statements themselves, written by humans, lack a consistent structure and use non-standardized language, complicating comparative analyses. Additionally, O*NET tasks statements vary in the level of detail and complexity, limiting the ability to identify similar functions across roles.

Natural Language Processing (NLP) techniques, particularly with Large Language Models (LLMs), have affected data science by enabling the extraction of rich insights from unstructured data at unprecedented scales. For example, LLMs' few-shot learning captures complex skill patterns and handles ambiguous mentions in job ads. However, LLMs come with notable challenges, including high computational costs and a tendency for hallucinations, undermining their reliability and scalability in real-world applications.

The systems, methods, and devices disclosed herein address the above and other needs using a methodology for developing a comprehensive task framework that leverages artificial intelligence (AI) models, such as LLMs, and large-scale job ads data. The present disclosure presents an approach to task taxonomy design, which involves the decomposition and reconstruction of tasks into a hierarchical structure based on action-object pairings, systematically refined using AI models. The methodology extends to integrating the taxonomy with occupation and skill linkages derived from job ads, ensuring alignment with real-world workforce dynamics. Additionally, the present disclosure provides a visual analytics system that enables interactive exploration and analysis of tasks, occupations, and associated skills, highlighting its potential to transform workforce analysis.

Among other things, the systems, methods, and devices of the present disclosure address challenges in the comparative techniques by integrating domain knowledge into the LL M driven process and distilling their insights into smaller, domain-specific models. This approach ensures cost-effective and accurate processing of extensive job ads data, enabling the development of a robust and adaptable task framework. Additionally, the present disclosure provides techniques for presenting task frameworks and their insights, addressing the complex relationships among tasks, occupations, and skills in workforce analysis, by designing interactive visualization systems that balance usability, scalability, and complexity.

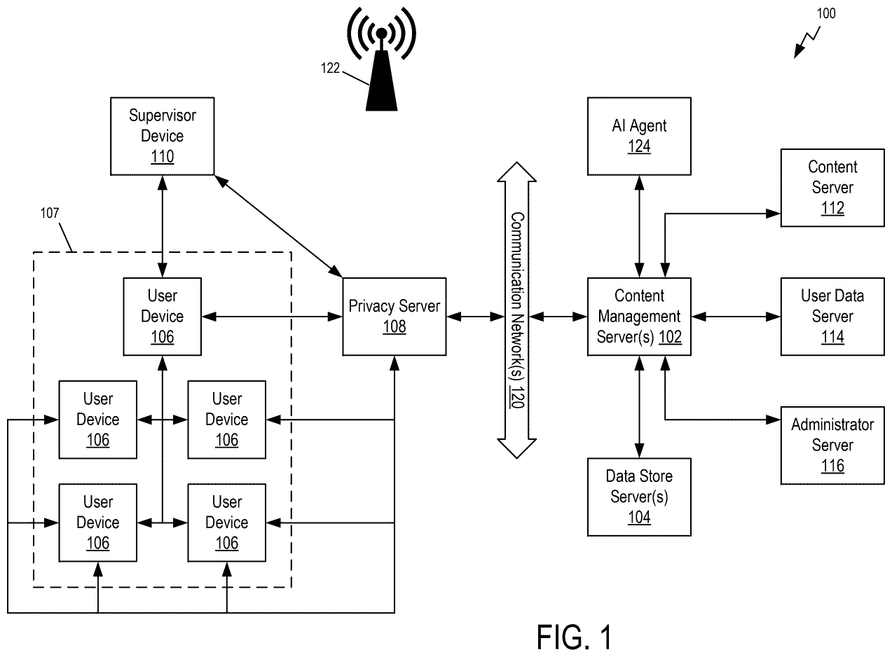

In some examples, the techniques described herein may be implemented with or by a content distribution network (CDN) ; for example, to gather underlying data, process it, or present it in an understandable manner. With reference now to FIG. 1, a block diagram is shown illustrating various components of a CDN 100 that implements and supports certain aspects and features described herein. In some aspects, the content distribution network 100 can comprise one or several physical components and/or one or several virtual components such as, for example, one or several cloud computing components. In some aspects, the content distribution network 100 can comprise a mixture of physical and cloud computing components.

Content distribution network 100 may include one or more content management servers 102. As discussed below in more detail, content management servers 102 may be any desired type of server including, for example, a rack server, a tower server, a miniature server, a blade server, a mini rack server, a mobile server, an ultra-dense server, a super server, or the like, and may include various hardware components, for example, a motherboard, a processing unit, memory systems, hard drives, network interfaces, power supplies, etc. Content management server 102 may include one or more server farms, clusters, or any other appropriate arrangement and/or combination of computer servers. Content management server 102 may act according to stored instructions located in a memory subsystem of the server 102, and may run an operating system, including any commercially available server operating system and/or any other operating systems discussed herein.

The content distribution network 100 may include one or more data store servers 104, such as database servers and file-based storage systems. The database servers 104 can access data that can be stored on a variety of hardware components. These hardware components can include, for example, components forming tier 0 storage, components forming tier 1 storage, components forming tier 2 storage, and/or any other tier of storage. In some embodiments, tier 0 storage refers to storage that is the fastest tier of storage in the database server 104, and particularly, the tier 0 storage is the fastest storage that is not RAM or cache memory. In some embodiments, the tier 0 memory can be embodied in solid state memory such as, for example, a solid-state drive (SSD) and/or flash memory.

In some aspects, the tier 1 storage refers to storage that is one or several higher performing systems in the memory management system, and that is relatively slower than tier 0 memory, and relatively faster than other tiers of memory. The tier 1 memory can be one or several hard disks that can be, for example, high-performance hard disks. These hard disks can be one or both of physically or communicatively connected such as, for example, by one or several fiber channels. In some embodiments, the one or several disks can be arranged into a disk storage system, and specifically can be arranged into an enterprise class disk storage system. The disk storage system can include any desired level of redundancy to protect data stored therein, and in one embodiment, the disk storage system can be made with grid architecture that creates parallelism for uniform allocation of system resources and balanced data distribution.

In some aspects, the tier 2 storage refers to storage that includes one or several relatively lower performing systems in the memory management system, as compared to the tier and tier 2 storages. Thus, tier 2 memory is relatively slower than tier 1 and tier 0 memories. Tier 2 memory can include one or several SATA-drives or one or several NL-SATA drives.

In some aspects, the one or several hardware and/or software components of the database server 104 can be arranged into one or several storage area networks (SAN), which one or several storage area networks can be one or several dedicated networks that provide access to data storage, and particularly that provide access to consolidated, block level data storage. A SAN typically has its own network of storage devices that are generally not accessible through the local area network (LAN) by other devices. The SAN allows access to these devices in a manner such that these devices appear to be locally attached to the user device.

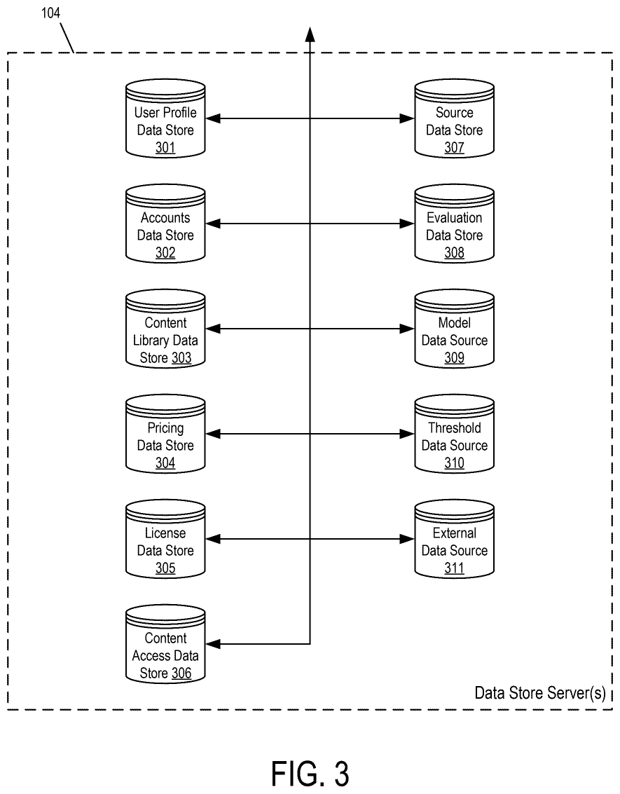

Data stores 104 may comprise stored data relevant to the functions of the content distribution network 100. Illustrative examples of data stores 104 that may be maintained in certain embodiments of the content distribution network 100 are described below in reference to FIG. 3. In some aspects, multiple data stores may reside on a single server 104, either using the same storage components of server 104 or using different physical storage components to assure data security and integrity between data stores. In other aspects, each data store may have a separate dedicated data store server 104.

Content distribution network 100 also may include one or more user devices 106 and/or supervisor devices 110. User devices 106 and supervisor devices 110 may display content received via the content distribution network 100, and may support various types of user interactions with the content. User devices 106 and supervisor devices 110 may include mobile devices such as smartphones, tablet computers, personal digital assistants, and wearable computing devices. Such mobile devices may run a variety of mobile operating systems, and may be enabled for Internet, e-mail, short message service (SM S), Bluetooth®, mobile radio-frequency identification (M-RFID), near-field communication (NFC), and/or other communication protocols. Other user devices 106 and supervisor devices 110 may be general purpose personal computers or special-purpose computing devices including, by way of example, personal computers, laptop computers, workstation computers, projection devices, and interactive room display systems. Additionally, user devices 106 and supervisor devices 110 may be any other electronic devices, such as thin-client computers, Internet-enabled gaming systems, business or home appliances, and/or personal messaging devices, capable of communicating over network(s) 120.

In different contexts of content distribution networks 100, user devices 106 and supervisor devices 110 may correspond to different types of specialized devices, for example, student devices and teacher devices in an educational network, employee devices and presentation devices in a company network, different gaming devices in a gaming network, etc. In some embodiments, user devices 106 and supervisor devices 110 may operate in the same physical location 107, such as a classroom or conference room. In such cases, the devices may contain components that support direct communications with other nearby devices, such as a wireless transceivers and wireless communications interfaces, Ethernet sockets or other LAN interfaces, etc. In other implementations, the user devices 106 and supervisor devices 110 need not be used at the same location 107, but may be used in remote geographic locations in which each user device 106 and supervisor device 110 may use security features and/or specialized hardware (e.g., hardware-accelerated Secure Socket Layer (SSL) and Secure Hypertext Transfer Protocol (HTTPS), WS-Security, firewalls, etc.) to communicate with the content management server 102 and/or other remotely-located user devices 106. Additionally, different user devices 106 and supervisor devices 110 may be assigned different designated roles, such as presenter devices, teacher devices, administrator devices, or the like, and in such cases the different devices may be provided with additional hardware and/or software components to provide content and support user capabilities not available to the other devices.

The content distribution network 100 also may include a privacy server 108 that maintains private user information at the privacy server 108 while using applications or services hosted on other servers. For example, the privacy server 108 may be used to maintain private data of a user within one jurisdiction even though the user is accessing an application hosted on a server (e.g., the content management server 102) located outside the jurisdiction. In such cases, the privacy server 108 may intercept communications between a user device 106 or supervisor device 110 and other devices that include private user information. The privacy server 108 may create a token or identifier that does not disclose the private information and may use the token or identifier when communicating with the other servers and systems, instead of using the user's private information.

As illustrated in FIG. 1, the content management server 102 may be in communication with one or more additional servers, such as a content server 112, a user data server 112, and/or an administrator server 116. Each of these servers may include some or all of the same physical and logical components as the content management server(s) 102, and in some cases, the hardware and software components of these servers 112-116 may be incorporated into the content management server(s) 102, rather than being implemented as separate computer servers.

Content server 112 may include hardware and software components to generate, store, and maintain the content resources for distribution to user devices 106 and other devices in the network 100. For example, in content distribution networks 100 used for professional training and educational purposes, content server 112 may include data stores of training materials, presentations, plans, syllabi, reviews, evaluations, interactive programs and simulations, course models, course outlines, and various training interfaces that correspond to different materials and/or different types of user devices 106. In content distribution networks 100 used for media distribution, interactive gaming, and the like, a content server 112 may include media content files such as music, movies, television programming, games, and advertisements.

User data server 114 may include hardware and software components that store and process data for multiple users relating to each user's activities and usage of the content distribution network 100. For example, the content management server 102 may record and track each user's system usage, including his or her user device 106, content resources accessed, and interactions with other user devices 106. This data may be stored and processed by the user data server 114, to support user tracking and analysis features. For instance, in the professional training and educational contexts, the user data server 114 may store and analyze each user's training materials viewed, presentations attended, courses completed, interactions, evaluation results, and the like. The user data server 114 may also include a repository for user-generated material, such as evaluations and tests completed by users, and documents and assignments prepared by users. In the context of media distribution and interactive gaming, the user data server 114 may store and process resource access data for multiple users (e.g., content titles accessed, access times, data usage amounts, gaming histories, user devices and device types, etc.).

Administrator server 116 may include hardware and software components to initiate various administrative functions at the content management server 102 and other components within the content distribution network 100. For example, the administrator server 116 may monitor device status and performance for the various servers, data stores, and/or user devices 106 in the content distribution network 100. When necessary, the administrator server 116 may add or remove devices from the network 100, and perform device maintenance such as providing software updates to the devices in the network 100. Various administrative tools on the administrator server 116 may allow authorized users to set user access permissions to various content resources, monitor resource usage by users and devices 106, and perform analyses and generate reports on specific network users and/or devices (e.g., resource usage tracking reports, training evaluations, etc.).

The content distribution network 100 may include one or more communication networks 120. Although only a single network 120 is identified in FIG. 1, the content distribution network 100 may include any number of different communication networks between any of the computer servers and devices shown in FIG. 1 and/or other devices described herein. Communication networks 120 may enable communication between the various computing devices, servers, and other components of the content distribution network 100. As discussed below, various implementations of content distribution networks 100 may employ different types of networks 120, for example, computer networks, telecommunications networks, wireless networks, and/or any combination of these and/or other networks.

The content distribution network 100 may include one or several navigation systems or features including, for example, the Global Positioning System (“GPS”), GALILEO, or the like, or location systems or features including, for example, one or several transceivers that can determine location of the one or several components of the content distribution network 100 via, for example, triangulation. All of these are depicted as navigation system 122.

In some embodiments, navigation system 122 can include one or several features that can communicate with one or several components of the content distribution network 100 including, for example, with one or several of the user devices 106 and/or with one or several of the supervisor devices 110. In some embodiments, this communication can include the transmission of a signal from the navigation system 122 which signal is received by one or several components of the content distribution network 100 and can be used to determine the location of the one or several components of the content distribution network 100.

The content distribution network 100 may include one or several artificial intelligence agents 124, also referred to herein as an AI agent 124, intelligence agent 124, and IA agent 124. The AI agent 124 can be an autonomous entity that can receive inputs via one or several sensors or from one or several user devices and can provide responses to those received inputs. In some embodiments, the AI agent 124 can comprise a question answering computing system, all or portions of an intelligent task framework system, pedagogical agent, or the like. In some embodiments, the functioning of the AI agent 124 can be predicated upon artificial intelligence, generative artificial intelligence, machine learning, LLM s, or the like. The AI agent 124 can reside in the server 102 and/or another component of the content distribution network 100, or can reside on a separate server or on separate computing resources. The AI agent 124 can be configured to receive inputs from the user device 106. The AI agent 124 can further launch a dialogue based on the received inputs and identify a remediation dialogue based on the received user inputs. In some embodiments, the AI agent 124 can determine termination of the dialogue and/or the remediation dialogue based on a user performance metric indicative of a user skill level.

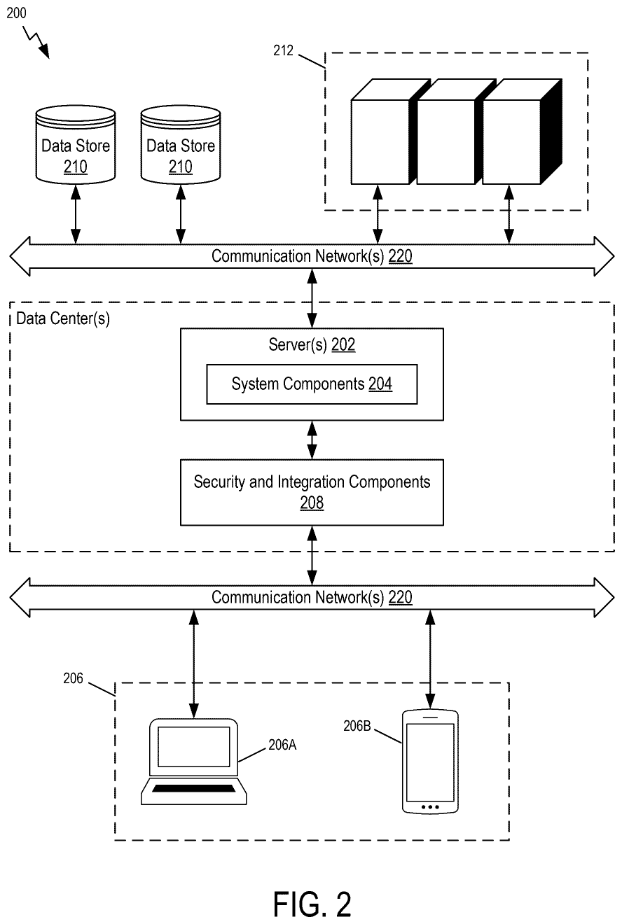

With reference to FIG. 2, an illustrative distributed computing environment 200 is shown. In some examples, the distributed computing environment 100 may include one or more computer servers 202 (e.g., data servers, computing devices, computers, etc.), one or more client computing devices 206, and other components that may implement certain aspects and features described herein. Although exemplary computing environment 200 is shown with two client computing devices 206, any number of client computing devices may be supported. In some implementations, the server 202 may correspond to the content management server 102 discussed above in FIG. 1, and the client computing devices 206 may correspond to the user devices 106. However, the computing environment 200 illustrated in FIG. 2 may correspond to any other combination of devices and servers configured to implement a client-server model or other distributed computing architecture.

Other devices, such as specialized sensor devices, etc., may interact with the client computing devices 206 and/or the servers 202. The servers 202, the client computing devices 206, or any other devices may be configured to implement a client-server model or any other distributed computing architecture. In some examples, the servers 202, the client computing devices 206, and any other disclosed devices may be communicatively coupled via one or more communication networks 220.

Client devices 206 may receive client applications from server 202 or from other application providers (e.g., public or private application stores). Server 202 may be configured to run one or more server software applications or services, for example, web-based or cloud-based services, to support content distribution and interaction with client devices 206. Users operating client devices 206 may in turn utilize one or more client applications (e.g., virtual client applications) to interact with server 202 to utilize the services provided by these components.

Various different subsystems and/or components 204 may be implemented on server 202. Users operating the client devices 206 may initiate one or more client applications to use services provided by these subsystems and components. The subsystems and components within the server 202 and client devices 206 may be implemented in hardware, firmware, software, or combinations thereof. Various different system configurations are possible in different distributed computing systems 200 and content distribution networks 100. The embodiment shown in FIG. 2 is thus one example of a distributed computing system and is not intended to be limiting.

As shown in FIG. 2, various security and integration components 208 may be used to send and manage communications between the server 202 and user devices 206 over one or more communication networks 220. The security and integration components 208 may include separate servers, such as web servers and/or authentication servers, and/or specialized networking components, such as firewalls, routers, gateways, load balancers, and the like. In some cases, the security and integration components 208 may correspond to a set of dedicated hardware and/or software operating at the same physical location and under the control of same entities as server 202. For example, components 208 may include one or more dedicated web servers and network hardware in a datacenter or a cloud infrastructure. In other examples, the security and integration components 208 may correspond to separate hardware and software components which may be operated at a separate physical location and/or by a separate entity.

Security and integration components 208 may implement various security features for data transmission and storage, such as authenticating users and restricting access to unknown or unauthorized users. In various implementations, security and integration components 208 may provide, for example, a file-based integration scheme or a service-based integration scheme for transmitting data between the various devices in the content distribution network 100. Security and integration components 208 also may use secure data transmission protocols and/or encryption for data transfers, for example, File Transfer Protocol (FTP), Secure File Transfer Protocol (SFTP), and/or Pretty Good Privacy (PGP) encryption.

In some embodiments, one or more web services may be implemented within the security and integration components 208 and/or elsewhere within the content distribution network 100. Such web services, including cross-domain and/or cross-platform web services, may be developed for enterprise use in accordance with various web service standards, such as RESTful web services (i.e., services based on the Representation State Transfer (REST) architectural style and constraints), and/or web services designed in accordance with the Web Service Interoperability (WS-I) guidelines. Some web services may use the SSL or Transport Layer Security (TLS) protocol to provide secure connections between the server 202 and user devices 206. SSL or TLS may use HTTP or HTTPS to provide authentication and confidentiality. In other examples, web services may be implemented using REST over HTTPS with the OAuth open standard for authentication, or using the WS-Security standard which provides for secure SOAP messages using XML encryption. In other examples, the security and integration components 208 may include specialized hardware for providing secure web services. For example, security and integration components 208 may include secure network appliances having built-in features such as hardware-accelerated SSL and HTTPS, WS-Security, and firewalls. Such specialized hardware may be installed and configured in front of any web servers, so that any external devices may communicate directly with the specialized hardware.

The communication networks 220 may be any type of network known in the art supporting data communication. As examples, network 220 may be a LAN (e.g., Ethernet, Token-Ring, etc.), a wide-area network (WAN; e.g., the Internet), an infrared or wireless network, a public switch telephone network (PSTN) , a virtual network, etc. The network 220 may use any available protocols, including but not limited to transmission control protocol/Internet protocol (TCP/IP), systems network architecture (SNA), Internet packet exchange (IPX), SSL, Transport Layer Security (TLS), HTTP, HTTPS, Institute of Electrical and Electronics (IEEE) 802.11 protocol suite or other wireless protocols, and the like.

Computing environment 200 also may include one or more data stores 210 and/or backend servers 212. In certain examples, the data stores 210 may correspond to data store server(s) 104 discussed above in FIG. 1, and back-end servers 212 may correspond to the various backend servers 112-116. Data stores 210 and servers 212 may reside in the same datacenter or may operate at a remote location from server 202. In some cases, one or more data stores 210 may reside on a non-transitory storage medium within the server 202. Other data stores 210 and back-end servers 212 may be remote from server 202 and configured to communicate with server 202 via one or more networks 220. In certain embodiments, data stores 210 and back-end servers 212 may reside in a SAN, or may use storage-as-a-service (STaaS) architectural model.

With reference to FIG. 3, an illustrative set of data stores and/or data store servers is shown, corresponding to the data store servers 104 of the content distribution network 100 discussed above in FIG. 1. One or more individual data stores 301-311 may reside in storage on a single computer server 104 (or a single server farm or cluster) under the control of a single entity, or may reside on separate servers operated by different entities and/or at remote locations. In some embodiments, data stores 301-311 may be accessed by the content management server 102 and/or other devices and servers within the network 100 (e.g., user devices 106, supervisor devices 110, administrator servers 116, etc.). Access to one or more of the data stores 301-311 may be limited or denied based on the processes, user credentials, and/or devices attempting to interact with the data store.

The paragraphs below describe examples of specific data stores that may be implemented within some embodiments of a content distribution network 100. It should be understood that the below descriptions of data stores 301-311, including their functionality and types of data stored therein, are illustrative and non-limiting. Data stores server architecture, design, and the execution of specific data stores 301-311 may depend on the context, size, and functional requirements of a content distribution network 100. For example, in content distribution systems 100 used for professional training and educational purposes, separate databases or file-based storage systems may be implemented in data store server(s) 104 to store trainee and/or student data, trainer and/or professor data, training module data and content descriptions, training results, evaluation data, and the like. In contrast, in content distribution systems 100 used for media distribution from content providers to subscribers, separate data stores may be implemented in data stores server(s) 104 to store listings of available content titles and descriptions, content title usage statistics, subscriber profiles, account data, payment data, network usage statistics, etc.

A user profile data store 301, also referred to herein as a user profile database 301, may include information relating to the end users within the content distribution network 100. This information may include user characteristics such as the user names, access credentials (e.g., logins and passwords), user preferences, and information relating to any previous user interactions within the content distribution network 100 (e.g., requested content, posted content, content modules completed, training scores or evaluations, other associated users, etc.). In some aspects, this information can relate to one or several individual end users such as, for example, one or several students, teachers, administrators, or the like, and in some aspects, this information can relate to one or several institutional end users such as, for example, one or several schools, groups of schools such as one or several school districts, one or several colleges, one or several universities, one or several training providers, or the like. In some aspects, this information can identify one or several user memberships in one or several groups such as, for example, a student's membership in a university, school, program, grade, course, class, or the like.

The user profile database 301 can include information relating to a user's status, location, or the like. This information can identify, for example, a device a user is using, the location of that device, or the like. In some aspects, this information can be generated based on any location detection technology including, for example, a navigation system 122, or the like.

Information relating to the user's status can identify, for example, logged-in status information that can indicate whether the user is presently logged-in to the content distribution network 100 and/or whether the log-in-is active. In some aspects, the information relating to the user's status can identify whether the user is currently accessing content and/or participating in an activity from the content distribution network 100.

In some aspects, information relating to the user's status can identify, for example, one or several attributes of the user's interaction with the content distribution network 100, and/or content distributed by the content distribution network 100. This can include data identifying the user's interactions with the content distribution network 100, the content consumed by the user through the content distribution network 100, or the like. In some aspects, this can include data identifying the type of information accessed through the content distribution network 100 and/or the type of activity performed by the user via the content distribution network 100, the lapsed time since the last time the user accessed content and/or participated in an activity from the content distribution network 100, or the like. In some aspects, this information can relate to a content program comprising an aggregate of data, content, and/or activities, and can identify, for example, progress through the content program, or through the aggregate of data, content, and/or activities forming the content program. In some aspects, this information can track, for example, the amount of time since participation in and/or completion of one or several types of activities, the amount of time since communication with one or several supervisors and/or supervisor devices 110, or the like.

In some aspects in which the one or several end users are individuals, and specifically are students, the user profile database 301 can further include information relating to these students' academic and/or educational history. This information can identify one or several courses of study that the student has initiated, completed, and/or partially completed, as well as grades received in those courses of study. In some embodiments, the student's academic and/or educational history can further include information identifying student performance on one or several tests, quizzes, and/or assignments. In some aspects, this information can be stored in a tier of memory that is not the fastest memory in the content delivery network 100.

The user profile database 301 can include information relating to one or several job seeker preferences. In some embodiments, for example, the user, also referred to herein as the job seeker or the seeker may have one or several preferred work preferences, one or several most effective work preferences, and/or the like. In some aspects, the job seeker's work preferences can be any preferences describing what type of position the job seeker operates best in or what type of position the job seeker prefers. In one aspect, these work preferences can include, for example, whether the job seeker prefers remote, hybrid, or in-office positions. In some aspects, the data identifying one or several seekers' work preferences can include data identifying a work preference based on the seeker's employment history. In some aspects, this information can be stored in a tier of memory that is not the fastest memory in the content delivery network 100.

In some aspects, the user profile data store 301 can further include information identifying one or several user skill levels. In some aspects, these one or several user skill levels can identify a skill level determined based on past performance by the user interacting with the content delivery network 100, and in some aspects, these one or several user skill levels can identify a predicted skill level determined based on past performance by the user interacting with the content delivery network 100 and one or several predictive models.

The user profile database 301 can further include information relating to one or several employers and/or representatives who are responsible for organizing, presenting, and/or managing the presentation of information to the seeker. In some aspects, user profile database 301 can include information identifying positions offered by the representatives, data identifying professional fields offered by the representatives, and/or data identifying positions that will be or are expected to be offered by the representatives. In some aspects, this can include information relating to one or several professions or one or several employers. In some aspects, the user profile database 301 can further include information indicating past evaluations and/or evaluation reports received by the representatives. In some aspects, the user profile database 301 can further include information relating to improvement suggestions received by the representative, training received by the representative, continuing education received by the representative, and/or the like. In some aspects, this information can be stored in a tier of memory that is not the fastest memory in the content delivery network 100.

An accounts data store 302, also referred to herein as an accounts database 302, may generate and store account data for different users in various roles within the content distribution network 100. For example, accounts may be created in an accounts data store 302 for individual end users, supervisors, administrator users, and entities such as companies or educational institutions. Account data may include account types, current account status, account characteristics, and any parameters, limits, restrictions associated with the accounts.

A content library data store 303, also referred to herein as a content library database 303, may include information describing the individual content items (or content resources or data packets) available via the content distribution network 100. In some aspects, these data packets in the content library database 303 can be linked to form an object network. In some aspects, these data packets can be linked in the object network according to one or several sequential relationship which can be, in some aspects, prerequisite relationships that can, for example, identify the relative hierarchy and/or difficulty of the data objects. In some aspects, this hierarchy of data objects can be generated by the content distribution network 100 according to user experience with the object network, and in some aspects, this hierarchy of data objects can be generated based on one or several existing and/or external hierarchies such as, for example, a syllabus, a table of contents, or the like. In some aspects, for example, the object network can correspond to a syllabus such that content for the syllabus is embodied in the object network.

In some aspects, the content library data store 303 can comprise a syllabus, a schedule, or the like. In some aspects, the syllabus or schedule can identify one or several tasks and/or events relevant to the user. In some aspects, for example, when the user is a member of a group such as a professional organization, these tasks and/or events relevant to the user can identify one or several aspects or contacts related to the professional organization.

In some aspects, the library data store 303 may include metadata, properties, and other characteristics associated with the content resources stored in the content server 112. Such data may identify one or more aspects or content attributes of the associated content resources, for example, subject matter, access level, or skill level of the content resources, license attributes of the content resources (e.g., any limitations and/or restrictions on the licensable use and/or distribution of the content resource), price attributes of the content resources (e.g., a price and/or price structure for determining a payment amount for use or distribution of the content resource), rating attributes for the content resources (e.g., data indicating the evaluation or effectiveness of the content resource), and the like. In some aspects, the library data store 303 may be configured to allow updating of content metadata or properties, and to allow the addition and/or removal of information relating to the content resources. For example, content relationships may be implemented as graph structures, which may be stored in the library data store 303 or in an additional store for use by selection algorithms along with the other metadata.

In some aspects, the content library data store 303 can contain information used in evaluating responses received from users. In some aspects, for example, a user can receive content from the content distribution network 100 and can, subsequent to receiving that content, provide a response to the received content. In some aspects, for example, the received content can comprise one or several questions, prompts, or the like, and the response to the received content can comprise an answer to those one or several questions, prompts, or the like. In some aspects, information, referred to herein as “comparative data,” from the content library data store 303 can be used to determine whether the responses are the correct and/or desired responses.

In some aspects, the content library database 303 and/or the user profile database 301 can comprise an aggregation network, also referred to herein as a content network or content aggregation network. The aggregation network can comprise a plurality of content aggregations that can be linked together by, for example: creation by common user; relation to a common subject, topic, skill, or the like; creation from a common set of source material such as source data packets; or the like. In some aspects, the content aggregation can comprise a grouping of content comprising the presentation portion that can be provided to the user in the form of, for example, a flash card and an extraction portion that can comprise the desired response to the presentation portion such as for example, an answer to a flash card. In some aspects, one or several content aggregations can be generated by the content distribution network 100 and can be related to one or several data packets that can be, for example, organized in object network. In some aspects, the one or several content aggregations can be each created from content stored in one or several of the data packets.

In some aspects, the content aggregations located in the content library database 303 and/or the user profile database 301 can be associated with a user-creator of those content aggregations. In some aspects, access to content aggregations can vary based on, for example, whether a user created the content aggregations. In some aspects, the content library database 303 and/or the user profile database 301 can comprise a database of content aggregations associated with a specific user, and in some aspects, the content library database 303 and/or the user profile database 301 can comprise a plurality of databases of content aggregations that are each associated with a specific user. In some aspects, these databases of content aggregations can include content aggregations created by their specific user and, in some aspects, these databases of content aggregations can further include content aggregations selected for inclusion by their specific user and/or a supervisor of that specific user. In some aspects, these content aggregations can be arranged and/or linked in a hierarchical relationship similar to the data packets in the object network and/or linked to the object network in the object network or the tasks or skills associated with the data packets in the object network or the syllabus or schedule.

In some aspects, the content aggregation network, and the content aggregations forming the content aggregation network can be organized according to the object network and/or the hierarchical relationships embodied in the object network. In some aspects, the content aggregation network, and/or the content aggregations forming the content aggregation network can be organized according to one or several tasks identified in the syllabus, schedule or the like.

A pricing data store 304 may include pricing information and/or pricing structures for determining payment amounts for providing access to the content distribution network 100 and/or the individual content resources within the network 100. In some cases, pricing may be determined based on a user's access to the content distribution network 100, for example, a time-based subscription fee, or pricing based on network usage. In other cases, pricing may be tied to specific content resources. Certain content resources may have associated pricing information, whereas other pricing determinations may be based on the resources accessed, the profiles and/or accounts of the user, and the desired level of access (e.g., duration of access, network speed, etc.). Additionally, the pricing data store 304 may include information relating to compilation pricing for groups of content resources, such as group prices and/or price structures for groupings of resources.

A license data store 305 may include information relating to licenses and/or licensing of the content resources within the content distribution network 100. For example, the license data store 305 may identify licenses and licensing terms for individual content resources and/or compilations of content resources in the content server 112, the rights holders for the content resources, and/or common or large-scale right holder information such as contact information for rights holders of content not included in the content server 112.

A content access data store 306 may include access rights and security information for the content distribution network 100 and specific content resources. For example, the content access data store 306 may include login information (e.g., user identifiers, logins, passwords, etc.) that can be verified during user login attempts to the network 100. The content access data store 306 also may be used to store assigned user roles and/or user levels of access. For example, a user's access level may correspond to the sets of content resources and/or the client or server applications that the user is permitted to access. Certain users may be permitted or denied access to certain applications and resources based on their subscription level, training program, supervisory level, etc. Certain users may have supervisory access over one or more end users, allowing the supervisor to access all or portions of the end user's content, activities, evaluations, etc. Additionally, certain users may have administrative access over some users and/or some applications in the content management network 100, allowing such users to add and remove user accounts, modify user access permissions, perform maintenance updates on software and servers, etc.

A source data store 307 may include information relating to the source of the content resources available via the content distribution network. For example, a source data store 307 may identify the authors and originating devices of content resources, previous pieces of data and/or groups of data originating from the same authors or originating devices, and the like.

An evaluation data store 308 may include information used to direct the evaluation of users and content resources in the content management network 100. In some aspects, the evaluation data store 308 may contain, for example, the analysis criteria and the analysis guidelines for evaluating users (e.g., trainees/students, gaming users, media content consumers, etc.) and/or for evaluating the content resources in the network 100. The evaluation data store 308 also may include information relating to evaluation processing tasks, for example, the identification of users and user devices 106 that have received certain content resources or accessed certain applications, the status of evaluations or evaluation histories for content resources, users, or applications, and the like. Evaluation criteria may be stored in the evaluation data store 308 including data and/or instructions in the form of one or several electronic rubrics or scoring guides for use in the evaluation of the content, users, or applications. The evaluation data store 308 also may include past evaluations and/or evaluation analyses for users, content, and applications, including relative rankings, characterizations, explanations, and the like.

A model data store 309, also referred to herein as a model database 309, can store information relating to one or several predictive models which predictive models can be, for example, statistical models. In some aspects, these can include one or several evidence models, risk models, skill models, or the like. In some aspects, an evidence model can be a mathematically-based statistical model. The evidence model can be based on, for example, Item Response Theory (IRT), Bayesian Network (Bayes net), Performance Factor Analysis (PFA), or the like. The evidence model can, in some aspects, be customizable to a user and/or to one or several content items. Specifically, one or several inputs relating to the user and/or to one or several content items can be inserted into the evidence model. These inputs can include, for example, one or several measures of user skill level, one or several measures of content item difficulty and/or skill level, or the like. The customized evidence model can then be used to predict the likelihood of the user providing desired or undesired responses to one or several of the content items.

In some aspects, the risk models can include one or several models that can be used to calculate one or several model function values. In some aspects, these one or several model function values can be used to calculate a risk probability, which risk probability can characterize the risk of a user such as a student-user failing to achieve a desired outcome such as, for example, failing to correctly respond to one or several data packets, failure to achieve a desired level of completion of a program, for example in a pre-defined time period, failure to achieve a desired learning outcome, or the like. In some aspects, the risk probability can identify the risk of the student-user failing to complete 60% of the program.

In some aspects, these models can include a plurality of model functions including, for example, a first model function, a second model function, a third model function, and a fourth model function. In some aspects, some or all of the model functions can be associated with a portion of the program such as, for example, a completion stage and/or completion status of the program. In one aspect, for example, the first model function can be associated with a first completion status, the second model function can be associated with a second completion status, the third model function can be associated with a third completion status, and the fourth model function can be associated with a fourth completion status. In some aspects, these completion statuses can be selected such that some or all of these completion statuses are less than the desired level of completion of the program. Specifically, in some aspects, these completion statuses can be selected to all be at less than 60% completion of the program, and more specifically, in some aspects, the first completion status can be at 20% completion of the program, the second completion status can be at 30% completion of the program, the third completion status can be at 40% completion of the program, and the fourth completion status can be at 50% completion of the program. Similarly, any desired number of model functions can be associated with any desired number of completion statuses.

In some aspects, a model function can be selected from the plurality of model functions based on a seeker's progress through a program (e.g., a training program). In some aspects, the seeker's progress can be compared to one or several status trigger thresholds, each of which status trigger thresholds can be associated with one or more of the model functions. If one of the status triggers is triggered by the seeker's progress, the corresponding one or several model functions can be selected.

The model functions can comprise a variety of types of models and/or functions. In some aspects, each of the model functions outputs a function value that can be used in calculating a risk probability. This function value can be calculated by performing one or several mathematical operations on one or several values indicative of one or several user attributes and/or user parameters, also referred to herein as program status parameters. In some aspects, each of the model functions can use the same program status parameters, and in some aspects, the model functions can use different program status parameters. In some aspects, the model functions use different program status parameters when at least one of the model functions uses at least one program status parameter that is not used by others of the model functions.

In some aspects, a skill model can comprise a statistical model identifying a predictive skill level of one or several job seekers. In some aspects, this model can identify a single skill level of a seeker and/or a range of possible skill levels of a seeker. In some aspects, this statistical model can identify a skill level of a seeker and an error value or error range associated with that skill level. In some aspects, the error value can be associated with a confidence interval determined based on a confidence level. Thus, in some aspects, as the number of interactions with the content distribution network increases, the confidence level can increase and the error value can decrease such that the range identified by the error value about the predicted skill level is smaller.

A threshold database 310, also referred to herein as a threshold database, can store one or several threshold values. These one or several threshold values can delineate between states or conditions. In one exemplary aspect, for example, a threshold value can delineate between an acceptable user performance and an unacceptable user performance, between content appropriate for a user and content that is inappropriate for a user, between risk levels, or the like.

In addition to the illustrative data stores described above, data store server(s) 104 (e.g., database servers, file-based storage servers, etc.) may include one or more external data aggregators 311. External data aggregators 311 may include third-party data sources accessible to the content management network 100, but not maintained by the content management network 100. External data aggregators 311 may include any electronic information source relating to the users, content resources, or applications of the content distribution network 100. For example, external data aggregators 311 may be third-party data stores containing demographic data, education-related data, consumer sales data, health-related data, and the like. Illustrative external data aggregators 311 may include, for example, social networking web servers, public records data stores, learning management systems, educational institution servers, business servers, consumer sales data stores, medical record data stores, etc. Data retrieved from various external data aggregators 311 may be used to verify and update user account information, suggest user content, and perform user and content evaluations.

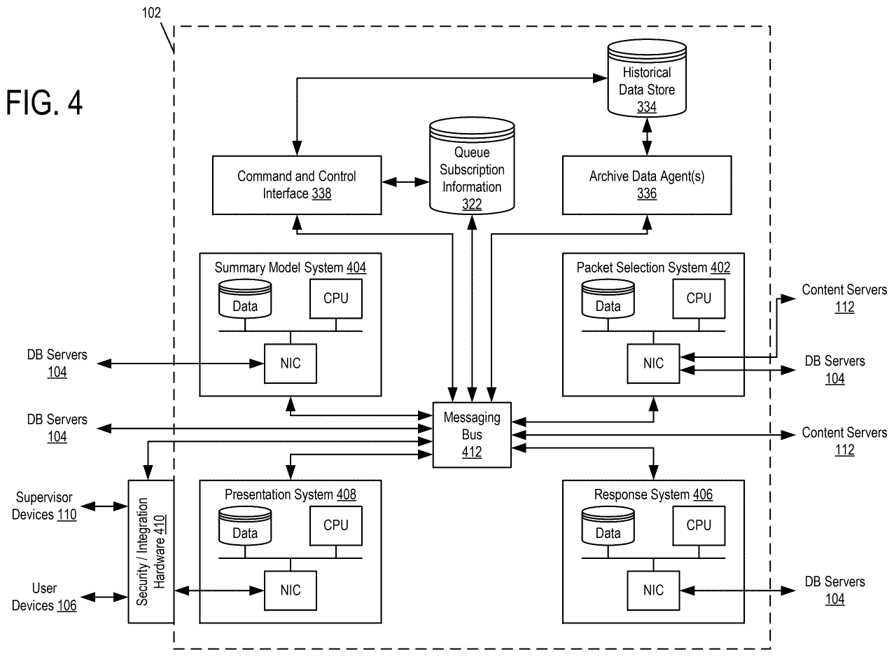

With reference now to FIG. 4, a block diagram is shown illustrating an aspect of one or more content management servers 102 within a content distribution network 100. In such an aspect, content management server 102 performs internal data gathering and processing of streamed content along with external data gathering and processing. Other aspects could have either all external or all internal data gathering. This aspect allows reporting timely information that might be of interest to the reporting party or other parties. In this aspect, the content management server 102 can monitor gathered information from several sources to allow it to make timely business and/or processing decisions based upon that information. For example, reports of user actions and/or responses, as well as the status and/or results of one or several processing tasks could be gathered and reported to the content management server 102 from a number of sources.

Internally, the content management server 102 gathers information from one or more internal components 402-408. The internal components 402-408 gather and/or process information relating to such things as: content provided to users; content consumed by users; responses provided by users; user skill levels; content difficulty levels; next content for providing to users; etc. The internal components 402-408 can report the gathered and/or generated information in real-time, near real-time or along another timeline. To account for any delay in reporting information, a time stamp or staleness indicator can inform others of how timely the information was sampled. The content management server 102 can opt to allow third parties to use internally or externally gathered information that is aggregated within the server 102 by subscription to the content distribution network 100.

A command and control (CC) interface 338 configures the gathered input information to an output of data streams, also referred to herein as content streams. APIs for accepting gathered information and providing data streams are provided to third parties external to the server 102 who want to subscribe to data streams. The server 102 or a third party can design as yet undefined A Pls using the CC interface 338. The server 102 can also define authorization and authentication parameters using the CC interface 338 such as authentication, authorization, login, and/or data encryption. CC information is passed to the internal components 402-408 and/or other components of the content distribution network 100 through a channel separate from the gathered information or data stream in this aspect, but other aspects could embed CC information in these communication channels. The CC information allows throttling information reporting frequency, specifying formats for information and data streams, deactivation of one or several internal components 402-408 and/or other components of the content distribution network 100, updating authentication and authorization, etc.

The various data streams that are available can be researched and explored through the CC interface 338. Those data stream selections for a particular subscriber, which can be one or several of the internal components 402-408 and/or other components of the content distribution network 100, are stored in the queue subscription information database 322. The server 102 and/or the CC interface 338 then routes selected data streams to processing subscribers that have selected delivery of a given data stream. Additionally, the server 102 also supports historical queries of the various data streams that are stored in an historical data store 334 as gathered by an archive data agent 336. Through the CC interface 238 various data streams can be selected for archiving into the historical data store 334.

Components of the content distribution network 100 outside of the server 102 can also gather information that is reported to the server 102 in real-time, near real-time or along another timeline. There is a defined A PI between those components and the server 102. Each type of information or variable collected by server 102 falls within a defined A PI or multiple A Pls. In some cases, the CC interface 338 is used to define additional variables to modify an A PI that might be of use to processing subscribers. The additional variables can be passed to all processing subscribes or just a subset. For example, a component of the content distribution network 100 outside of the server 102 may report a user response but define an identifier of that user as a private variable that would not be passed to processing subscribers lacking access to that user and/or authorization to receive that user data. Processing subscribers having access to that user and/or authorization to receive that user data would receive the subscriber identifier along with response reported that component. Encryption and/or unique addressing of data streams or sub-streams can be used to hide the private variables within the messaging queues.

The user devices 106 and/or supervisor devices 110 communicate with the server 102 through security and/or integration hardware 410. The communication with security and/or integration hardware 410 can be encrypted or not. For example, a socket using a TCP connection could be used. In addition to TCP, other transport layer protocols like SCTP and UDP could be used in some aspects to intake the gathered information. A protocol such as SSL could be used to protect the information over the TCP connection. Authentication and authorization can be performed to any user devices 106 and/or supervisor device interfacing to the server 102. The security and/or integration hardware 410 receives the information from one or several of the user devices 106 and/or the supervisor devices 110 by providing the API and any encryption, authorization, and/or authentication. In some cases, the security and/or integration hardware 410 reformats or rearranges this received information.

The messaging bus 412, also referred to herein as a messaging queue or a messaging channel, can receive information from the internal components of the server 102 and/or components of the content distribution network 100 outside of the server 102 and distribute the gathered information as a data stream to any processing subscribers that have requested the data stream from the messaging queue 412. As indicate in FIG. 4, processing subscribers are indicated by a connector to the messaging bus 412, the connector having an arrowhead pointing away from the messaging bus 412. Only data streams within the messaging queue 412 that a particular processing subscriber has subscribed to may be read by that processing subscriber if received at all. Gathered information sent to the messaging queue 412 is processed and returned in a data stream in a fraction of a second by the messaging queue 412. Various multi casting and routing techniques can be used to distribute a data stream from the messaging queue 412 that a number of processing subscribers have requested. Protocols such as Multicast or multiple Unicast could be used to distribute streams within the messaging queue 412. Additionally, transport layer protocols like TCP, SCTP and UDP could be used in various aspects.

Through the CC interface 338, an external or internal processing subscriber can be assigned one or more data streams within the messaging queue 412. A data stream is a particular type of message in a particular category. For example, a data stream can comprise all of the data reported to the messaging bus 412 by a designated set of components. One or more processing subscribers could subscribe and receive the data stream to process the information and make a decision and/or feed the output from the processing as gathered information fed back into the messaging queue 412. Through the CC interface 338 a developer can search the available data streams or specify a new data stream and its A PL The new data stream might be determined by processing a number of existing data streams with a processing subscriber.

The CDN 110 has internal processing subscribers 402-408 that process assigned data streams to perform functions within the server 102. Internal processing subscribers 402-408 could perform functions such as providing content to a user, receiving a response from a user, determining the correctness of the received response, updating one or several models based on the correctness of the response, recommending new content for providing to one or several users, or the like. The internal processing subscribers 402-408 can decide filtering and weighting of records from the data stream. To the extent that decisions are made based upon analysis of the data stream, each data record is time stamped to reflect when the information was gathered such that additional credibility could be given to more recent results, for example. Other aspects may filter out records in the data stream that are from an unreliable source or stale. For example, a particular contributor of information may prove to have less than optimal gathered information and that could be weighted very low or removed altogether.

Internal processing subscribers 402-408 may additionally process one or more data streams to provide different information to feed back into the messaging queue 412 to be part of a different data stream. For example, hundreds of user devices 106 could provide responses that are put into a data stream on the messaging queue 412. An internal processing subscriber 402-408 could receive the data stream and process it to determine the difficulty of one or several data packets provided to one or several users, and supply this information back onto the messaging queue 412 for possible use by other internal and external processing subscribers.

As mentioned above, the CC interface 338 allows the CDN 110 to query historical messaging queue 412 information. An archive data agent 336 listens to the messaging queue 412 to store data streams in a historical database 334. The historical database 334 may store data streams for varying amounts of time and may not store all data streams. Different data streams may be stored for different amounts of time.

With regard to the components 402-48, the content management server(s) 102 may include various server hardware and software components that manage the content resources within the content distribution network 100 and provide interactive and adaptive content to users on various user devices 106. For example, content management server(s) 102 may provide instructions to and receive information from the other devices within the content distribution network 100, in order to manage and transmit content resources, user data, and server or client applications executing within the network 100.

A content management server 102 may include a packet selection system 402. The packet selection system 402 may be implemented using dedicated hardware within the content distribution network 100 (e.g., a packet selection server 402), or using designated hardware and software resources within a shared content management server 102. In some aspects, the packet selection system 402 may adjust the selection and adaptive capabilities of content resources to match the needs and desires of the users receiving the content. For example, the packet selection system 402 may query various data stores and servers 104 to retrieve user information, such as user preferences and characteristics (e.g., from a user profile data store 301), user access restrictions to content recourses (e.g., from a content access data store 306), previous user results and content evaluations (e.g., from an evaluation data store 308), and the like. Based on the retrieved information from data stores 104 and other data sources, the packet selection system 402 may modify content resources for individual users.

In some aspects, the packet selection system 402 can include a recommendation engine, also referred to herein as an adaptive recommendation engine. In some aspects, the recommendation engine can select one or several pieces of content, also referred to herein as data packets, for providing to a user. These data packets can be selected based on, for example, the information retrieved from the database server 104 including, for example, the user profile database 301, the content library database 303, the model database 309, or the like. In some aspects, these one or several data packets can be adaptively selected and/or selected according to one or several selection rules. In one aspect, for example, the recommendation engine can retrieve information from the user profile database 301 identifying, for example, a skill or experience level of the user. The recommendation engine can further retrieve information from the content library database 303 identifying, for example, potential data packets for providing to the user and the difficulty of those data packets and/or the skill level associated with those data packets.

The recommendation engine can identify one or several potential data packets for providing and/or one or several data packets for providing to the user based on, for example, one or several rules, models, predictions, or the like. The recommendation engine can use the skill level of the user to generate a prediction of the likelihood of one or several users providing a desired response to some or all of the potential data packets. In some aspects, the recommendation engine can pair one or several data packets with selection criteria that may be used to determine which packet should be delivered to a student-user based on one or several received responses from that student-user. In some aspects, one or several data packets can be eliminated from the pool of potential data packets if the prediction indicates either too high a likelihood of a desired response or too low a likelihood of a desired response. In some aspects, the recommendation engine can then apply one or several selection criteria to the remaining potential data packets to select a data packet for providing to the user. These one or several selection criteria can be based on, for example, criteria relating to a desired estimated time for receipt of response to the data packet, one or several content parameters, one or several assignment parameters, or the like.

A content management server 102 also may include a summary model system 404. The summary model system 404 may be implemented using dedicated hardware within the content distribution network 100 (e.g., a summary model server 404), or using designated hardware and software resources within a shared content management server 102. In some aspects, the summary model system 404 may monitor the progress of users through various types of content resources and groups, such as media compilations, courses or curriculums in training or educational contexts, interactive gaming environments, and the like. For example, the summary model system 404 may query one or more databases and/or data store servers 104 to retrieve user data such as associated content compilations or programs, content completion status, user goals, results, and the like.

A content management server 102 also may include a response system 406, which can include, in some aspects, a response processor. The response system 406 may be implemented using dedicated hardware within the content distribution network 100 (e.g., a response server 406), or using designated hardware and software resources within a shared content management server 102. The response system 406 may be configured to receive and analyze information from user devices 106. For example, various ratings of content resources submitted by users may be compiled and analyzed, and then stored in a data store (e.g., a content library data store 303 and/or evaluation data store 308) associated with the content. In some aspects, the response server 406 may analyze the information to determine the effectiveness or appropriateness of content resources with, for example, a subject matter, an age group, a skill level, or the like. In some aspects, the response system 406 may provide updates to the packet selection system 402 or the summary model system 404, with the attributes of one or more content resources or groups of resources within the network 100. The response system 406 also may receive and analyze user evaluation data from user devices 106, supervisor devices 110, and administrator servers 116, etc. For instance, response system 406 may receive, aggregate, and analyze user evaluation data for different types of users (e.g., end users, supervisors, administrators, etc.) in different contexts (e.g., media consumer ratings, trainee or student comprehension levels, teacher effectiveness levels, gamer skill levels, etc.).

In some aspects, the response system 406 can be further configured to receive one or several responses from the user and analyze these one or several responses. In some aspects, for example, the response system 406 can be configured to translate the one or several responses into one or several observables. As used herein, an observable is a characterization of a received response. In some aspects, the translation of the one or several responses into one or several observables can include determining whether the one or several responses are correct responses, also referred to herein as desired responses, or are incorrect responses, also referred to herein as undesired responses. In some aspects, the translation of the one or several responses into one or several observables can include characterizing the degree to which one or several responses are desired responses and/or undesired responses. In some aspects, one or several values can be generated by the response system 406 to reflect user performance in responding to the one or several data packets. In some aspects, these one or several values can comprise one or several scores for one or several responses and/or data packets.

A content management server 102 also may include a presentation system 408. The presentation system 408 may be implemented using dedicated hardware within the content distribution network 100 (e.g., a presentation server 408), or using designated hardware and software resources within a shared content management server 102. The presentation system 408 can include a presentation engine that can be, for example, a software module running on the content delivery system.

The presentation system 408, also referred to herein as the presentation module or the presentation engine, may receive content resources from the packet selection system 402 and/or from the summary model system 404, and provide the resources to user devices 106. The presentation system 408 may determine the appropriate presentation format for the content resources based on the user characteristics and preferences, and/or the device capabilities of user devices 106. If needed, the presentation system 408 may convert the content resources to the appropriate presentation format and/or compress the content before transmission. In some aspects, the presentation system 408 may also determine the appropriate transmission media and communication protocols for transmission of the content resources.

In some aspects, the presentation system 408 may include specialized security and integration hardware 410, along with corresponding software components to implement the appropriate security features content transmission and storage, to provide the supported network and client access models, and to support the performance and scalability requirements of the network 100. The security and integration layer 410 may include some or all of the security and integration components 208 discussed above in FIG. 2, and may control the transmission of content resources and other data, as well as the receipt of requests and content interactions, to and from the user devices 106, supervisor devices 110, administrative servers 116, and other devices in the network 100.

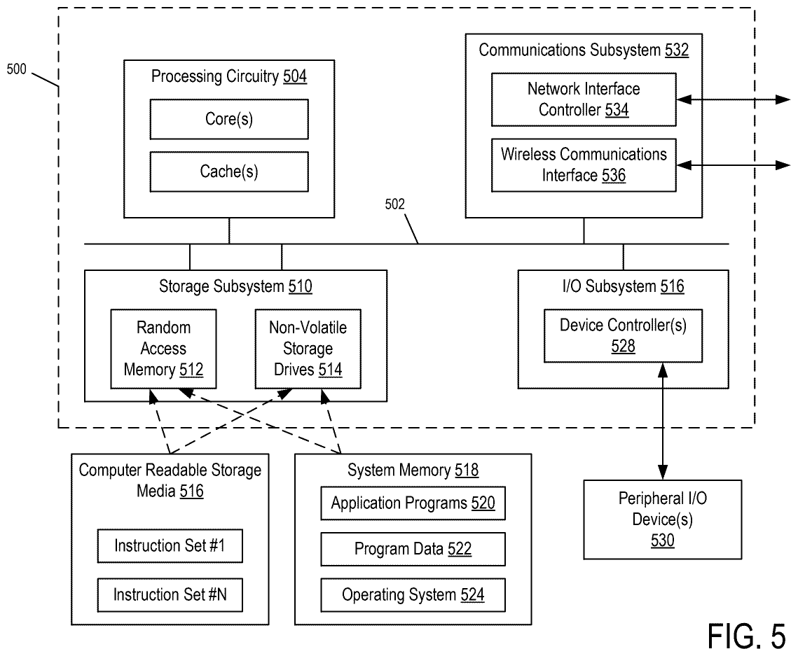

With reference now to FIG. 5, a block diagram of an example computing system 500 is shown. The computing system 500 (e.g., one or more computers) may correspond to any one or more of the computing devices or servers of the distribution computing environment 200, or any other computing devices described herein. In an example, the computing system 500 may represent an example of one or more servers 202 and/or of one or more servers 212 of the distribution computing environment 200. In another example, the computing system 500 may represent an example of the client computing devices 206 of the distribution computing environment 200. In some examples, the computing system 500 may represent a combination of one or more computing devices and/or servers of the distribution computing environment 200.

In some examples, the computing system 500 may include processing circuitry 504, such as one or more processing unit(s), processor(s), etc. In some examples, the processing circuitry 504 may communicate (e.g., interface) with a number of peripheral subsystems via a bus subsystem 502. These peripheral subsystems may include, for example, a storage subsystem 510, an input/output (I/O) subsystem 526, and a communications subsystem 532.

In some examples, the computing system 500 may include processing circuitry 504, such as one or more processing units, processors, etc. In some examples, the processing circuitry 504 may communicate (e.g., interface) with a number of peripheral subsystems via a bus subsystem 502. These peripheral subsystems may include, for example, a storage subsystem 510, an input/output (I/O) subsystem 526, and a communications subsystem 532.

In some examples, the bus subsystem 502 provides a mechanism for intended communication between the various components and subsystems of computing system 500. Although the bus subsystem 502 is shown schematically as a single bus, alternative embodiments of the bus subsystem may utilize multiple buses. In some examples, the bus subsystem 502 may include a memory bus, memory controller, peripheral bus, and/or local bus using any of a variety of bus architectures (e.g., Industry Standard Architecture (ISA), Micro Channel Architecture (MCA), Enhanced ISA (EISA), Video Electronics Standards Association (VESA), and/or Peripheral Component Interconnect (PCI) bus, possibly implemented as a Mezzanine bus manufactured to the IEEE P1386.1 standard).

In some examples, the I/O subsystem 526 may include one or more device controller(s) 528 for one or more user interface input devices and/or user interface output devices, possibly integrated with the computing system 500 (e.g., integrated audio/video systems, and/or touchscreen displays), or may be separate peripheral devices which are attachable/detachable from the computing system 500. Input may include keyboard or mouse input, audio input (e.g., spoken commands), motion sensing, gesture recognition (e.g., eye gestures), etc. As non-limiting examples, input devices may include a keyboard, pointing devices (e.g., mouse, trackball, and associated input), touchpads, touch screens, scroll wheels, click wheels, dials, buttons, switches, keypad, audio input devices, voice command recognition systems, microphones, three dimensional (3D) mice, joysticks, pointing sticks, gamepads, graphic tablets, speakers, digital cameras, digital camcorders, portable media players, webcams, image scanners, fingerprint scanners, barcode readers, 3D scanners, 3D printers, laser rangefinders, eye gaze tracking devices, medical imaging input devices, MIDI keyboards, digital musical instruments, and the like. In general, use of the term “output device” is intended to include all possible types of devices and mechanisms for outputting information from computing system 500, such as to a user (e.g., via a display device) or any other computing system, such as a second computing system 500. In an example, output devices may include one or more display subsystems and/or display devices that visually convey text, graphics and audio/video information (e.g., cathode ray tube (CRT) displays, flat-panel devices, liquid crystal display (LCD) or plasma display devices, organic light emitting display (OLED) devices, projection devices, touch screens, etc.), and/or may include one or more non-visual display subsystems and/or non-visual display devices, such as audio output devices, etc. As non-limiting examples, output devices may include, indicator lights, monitors, printers, speakers, headphones, automotive navigation systems, plotters, voice output devices, modems, etc.

In some examples, the computing system 500 may include one or more storage subsystems 510, including hardware and software components used for storing data and program instructions, such as system memory 518 and computer-readable storage media 516. In some examples, the system memory 518 and/or the computer-readable storage media 516 may store and/or include program instructions that are loadable and executable on the processor(s) 504. In an example, the system memory 518 may load and/or execute an operating system 524, program data 522, server applications, application program(s) 520 (e.g., client applications), Internet browsers, mid-tier applications, etc. In some examples, the system memory 518 may further store data generated during execution of these instructions.

In some examples, the system memory 518 may be stored in volatile memory (e.g., random-access memory (RAM) 512, including static random-access memory (SRAM) or dynamic random-access memory (DRAM) ). In an example, the RAM 512 may contain data and/or program modules that are immediately accessible to and/or operated and executed by the processing circuitry 504. In some examples, the system memory 518 may also be stored in non-volatile storage drives 514 (e.g., read-only memory (ROM) , flash memory, etc.). In an example, a basic input/output system (BIOS), containing the basic routines that help to transfer information between elements within the computing system 500 (e.g., during start-up), may typically be stored in the non-volatile storage drives 514.

In some examples, the storage subsystem 510 may include one or more tangible computer-readable storage media 516 for storing the basic programming and data constructs that provide the functionality of some embodiments. In an example, the storage subsystem 510 may include software, programs, code modules, instructions, etc., that may be executed by the processing circuitry 504, in order to provide the functionality described herein. In some examples, data generated from the executed software, programs, code, modules, or instructions may be stored within a data storage repository within the storage subsystem 510. In some examples, the storage subsystem 510 may also include a computer-readable storage media reader connected to the computer-readable storage media 516.

In some examples, the computer-readable storage media 516 may contain program code, or portions of program code. Together and, optionally, in combination with the system memory 518, the computer-readable storage media 516 may comprehensively represent remote, local, fixed, and/or removable storage devices plus storage media for temporarily and/or more permanently containing, storing, transmitting, and/or retrieving computer-readable information. In some examples, the computer-readable storage media 516 may include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer-readable media. This can also include nontangible computer-readable media, such as data signals, data transmissions, or any other medium which can be used to transmit the desired information and which can be accessed by the computing system 500. In an illustrative and non-limiting example, the computer-readable storage media 516 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media.

In some examples, the computer-readable storage media 516 may include, but is not limited to, Zip® drives, flash memory cards, universal serial bus (USB) flash drives, secure digital (SD) cards, DVD disks, digital video tape, and the like. In some examples, the computer-readable storage media 516 may include, solid-state drives (SSD) based on non-volatile memory such as flash-memory based SSDs, enterprise flash drives, solid state ROM, and the like, SSDs based on volatile memory such as solid-state RAM, dynamic RAM, static RAM, DRAM-based SSDs, magneto-resistive RAM (M RAM) SSDs, and hybrid SSDs that use a combination of DRA M and flash memory-based SSDs. The disk drives and their associated computer-readable media may provide non-volatile storage of computer-readable instructions, data structures, program modules, and other data for the computing system 500.

In some examples, the communications subsystem 532 may provide a communication interface from the computing system 500 and external computing devices via one or more communication networks, LANs, WANs (e.g., the Internet), and various wireless telecommunications networks. As illustrated in FIG. 5, the communications subsystem 532 may include, for example, one or more network interface controllers (NICs) 534, such as Ethernet cards, A synchronous Transfer M ode NICs, Token Ring NICs, and the like, as well as one or more wireless communications interfaces 536, such as wireless network interface controllers (WNICs), wireless network adapters, and the like. Additionally, and/or alternatively, the communications subsystem 532 may include one or more modems (telephone, satellite, cable, ISDN) , synchronous or asynchronous digital subscriber line (DSL) units, Fire Wire® interfaces, USB® interfaces, and the like. Communications subsystem 532 also may include radio frequency (RF) transceiver components for accessing wireless voice and/or data networks (e.g., using cellular telephone technology, advanced data network technology, such as 3G, 4G, 5G or EDGE (enhanced data rates for global evolution), Wi-Fi (IEEE 802.11 family standards, or other mobile communication technologies, or any combination thereof), global positioning system (GPS) receiver components, and/or other components.

In some examples, the communications subsystem 532 may also receive input communication in the form of structured and/or unstructured data feeds, event streams, event updates, and the like, on behalf of one or more users who may use or access the computing system 500. In an example, the communications subsystem 532 may be configured to receive data feeds in real-time from users of social networks and/or other communication services, web feeds such as Rich Site Summary (RSS) feeds, and/or real-time updates from one or more third party information sources (e.g., data aggregators). Additionally, the communications subsystem 532 may be configured to receive data in the form of continuous data streams, which may include event streams of real-time events and/or event updates (e.g., sensor data applications, financial tickers, network performance measuring tools, clickstream analysis tools, automobile traffic monitoring, etc.). In some examples, the communications subsystem 532 may output such structured and/or unstructured data feeds, event streams, event updates, and the like to one or more data stores that may be in communication with one or more streaming data source computing systems (e.g., one or more data source computers, etc.) coupled to the computing system 500. The various physical components of the communications subsystem 532 may be detachable components coupled to the computing system 500 via a computer network (e.g., a communication network 220), a FireWire® bus, or the like, and/or may be physically integrated onto a motherboard of the computing system 500. In some examples, the communications subsystem 532 may be implemented in whole or in part by software.

Due to the ever-changing nature of computers and networks, the description of the computing system 500 depicted in the figure is intended only as a specific example. Many other configurations having more or fewer components than the system depicted in the figure are possible. For example, customized hardware might also be used and/or particular elements might be implemented in hardware, firmware, software, or a combination. Further, connection to other computing devices, such as network input/output devices, may be employed. Based on the disclosure and teachings provided herein, a person of ordinary skill in the art will appreciate other ways and/or methods to implement the various embodiments.

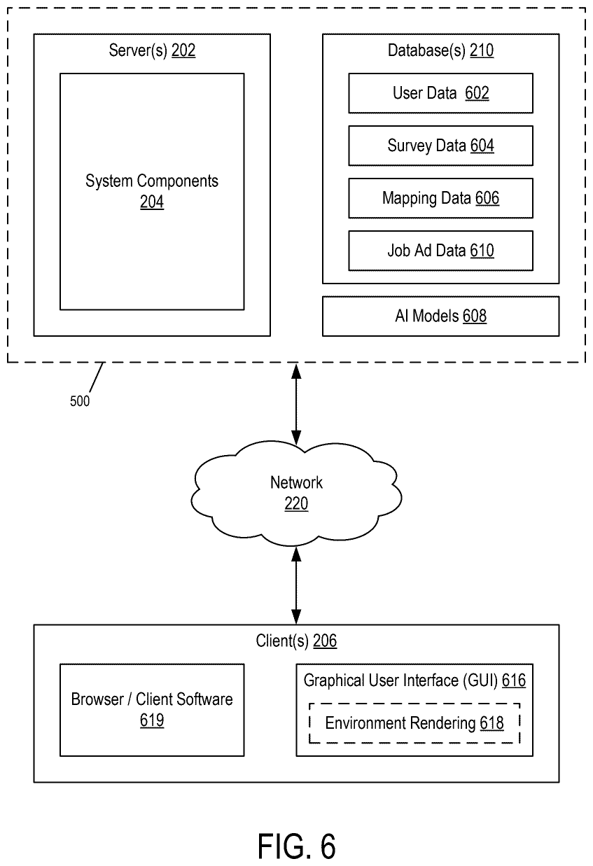

FIG. 6 illustrates a system level block diagram of a task framework system 600, such as a system for providing the disclosed artificial intelligence-based task framework analysis and management methodologies according to some examples. In some examples, such as where the system 600 is configured to provide individualized and/or customized content, the system 600 may include one or more databases 210, also referred to as data stores herein. The databases 210 may include a plurality of user data 602 (e.g., a set of user data items). In such examples, the system 600 may store and/or manage the user data 602 in accordance with one or more of the various techniques of the disclosure. In some examples, the user data 602 may include user responses, user history, user scores, user performance, user preferences, and the like. In some examples, the system 600 may collect and aggregate some or all user data points from various sources (e.g., platforms, a learner response assessment component, a personalization component, a personalization component, a practice generation component, etc.) to determine characteristics regarding the user. The characteristics regarding the user may be stored in the database 210. In further examples, the characteristics regarding the user may be received by other sources (e.g., third-party components). Database 210 may further store user data 602 about each of one or more learners, possibly enrolled in a class or an organization, and stored as a learner profile for each of the learners. In some embodiments, this data, at a high level, may derive data from a high level for a plurality dimensions and characteristics associated with each of the learners.

As non-limiting examples, this user data 602 regarding each learner may include data derived from, for example, employment histories, assessments, and/or other information. In some aspects, this data may include content from a previous position or assessment submitted by the job seeker. In some aspects, this data may include identification of fields or positions for which the learner believes he or she is qualified, possibly associated in database 210 with a current or previous position or assessment. In some embodiments, this data may include additional data derived by determining a seeker's interactions and/or results associated with one or more employment preferences stored in the database 210.

Furthermore, the database 210 may include one or more survey responses 604 or other data. In some examples, the survey responses 604 may include multiple interactions of a user, and an interaction may include a spoken response, a written response, a user selection (e.g., via a button in a GUI). In some examples, the survey responses 604 are generated during a chatbot conversation, questions and answers, tests, and other various user activities. In some examples, the survey responses 604 may correspond to previous items.

The database 210 may include a plurality of mapping data 606. In some aspects, the mapping data 606 may include one or more relationships between an occupation and a task as determined by a methodology other than that disclosed herein. The relationships may be identified and input into the system 600 by users, such as system administrators, course creators, instructors, etc., possibly via user input into a graphical user interface (GUI) stored on one or more client devices 206.

The system 500 may additionally include one or more AI models 608. In some examples, the A I models 608 can include generative A I models (e.g., LL M s and the like); machine learning models (e.g., recurrent neural networks (RNNs), convolutional neural networks (CNNs), deep learning models, transformer models, and the like); sequence-to-sequence models; word embeddings; memory networks; graph neural networks, or any other suitable artificial intelligence model. In further examples, the artificial intelligence models 608 can be stored in a remote or cloud server, which is communicatively coupled to the system server 202 over the network 220.

The database 210 may additionally include job advertisement data 610. The job advertisement data may be derived from a physical or electronic job database, and may include one or more tasks or operations, and/or provide means for the user to research this information in order to accomplish employment objectives. The job advertisement data 610 may include embellished data which is not found directly in the corresponding physical or electronic job database. In some implementations, some or all of the embellished data may be generated by the AI models 608. Some or all of the job advertisement data may be associated with a tag (e.g., metadata, related field in a database, etc.), for example to analyze or categorize the job advertisement data in relation to other data or to specific employment topics.

While FIG. 6 illustrates the database 210 as affirmatively including several different components (e.g., 602-606 and 610), this is merely exemplary and not limiting. In implementations, the database 210 may omit one or more of the components 602-606 and 610 if such components are not used, referenced, or implicated by the system 500.

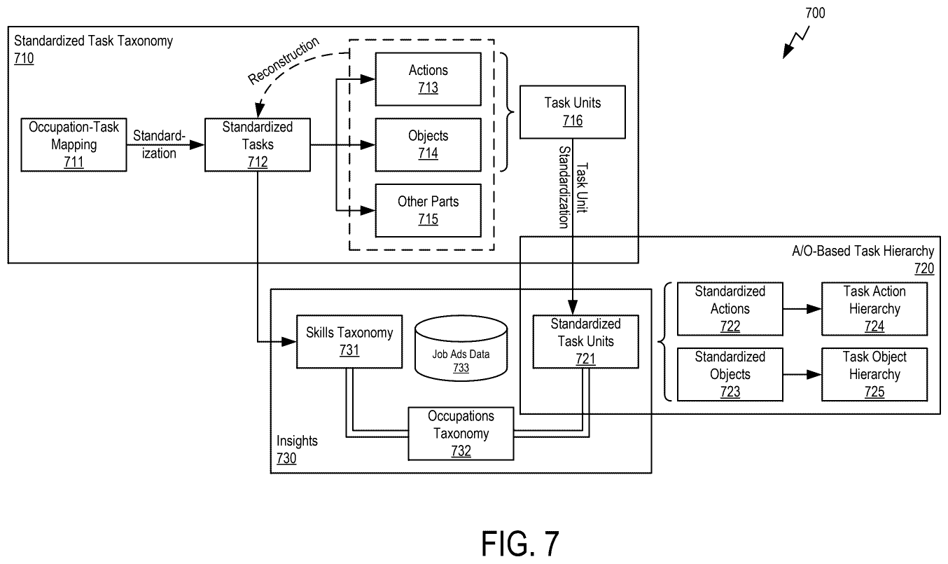

In some aspects of the present disclosure, the server 202 in coordination with the databases 210 may configure the system components 204 (e.g., AI models, which may be stored in the databases 210) for various functions, including, e.g., generating a GUI for presenting an employment task/operation interface to an employer or job seeker; initializing an interactive session window within the interface; receiving a user input via the GUI; responding to the user input; and the like. Any of the aforementioned functions may be combined, in any combination, by the system 500. For example, the system components 204 may be configured to implement one or more of the functions described below in relation to any one or more of FIGS. 7-9. The system components 204 may, in some examples, be implemented by an electronic processor of the server 202 (e.g., processing circuitry 504 of FIG. 5) executing instructions stored and retrieved from a memory of the server 202 (e.g., storage subsystem 510, computer readable storage media 516, and/or system memory 518 of FIG. 5).

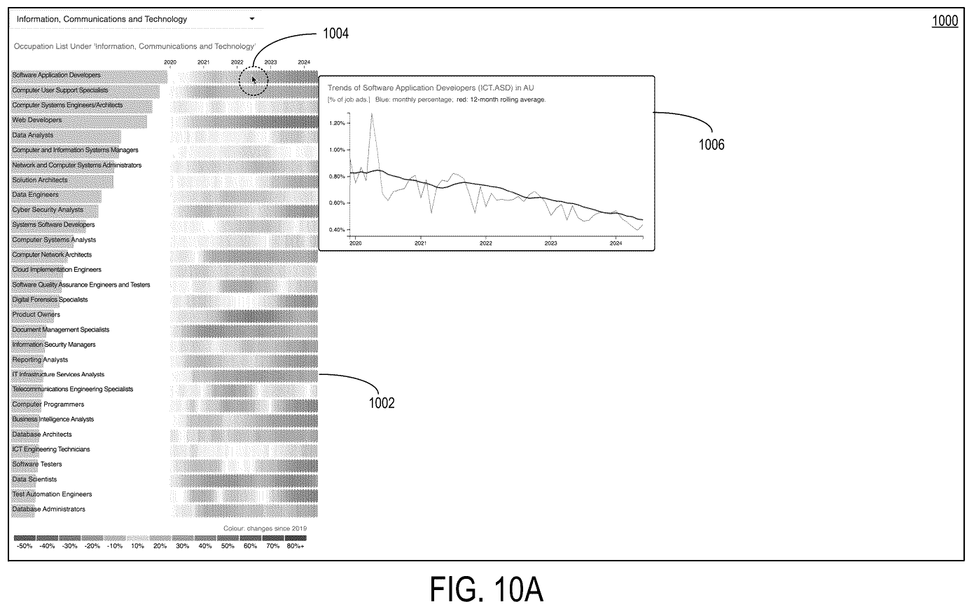

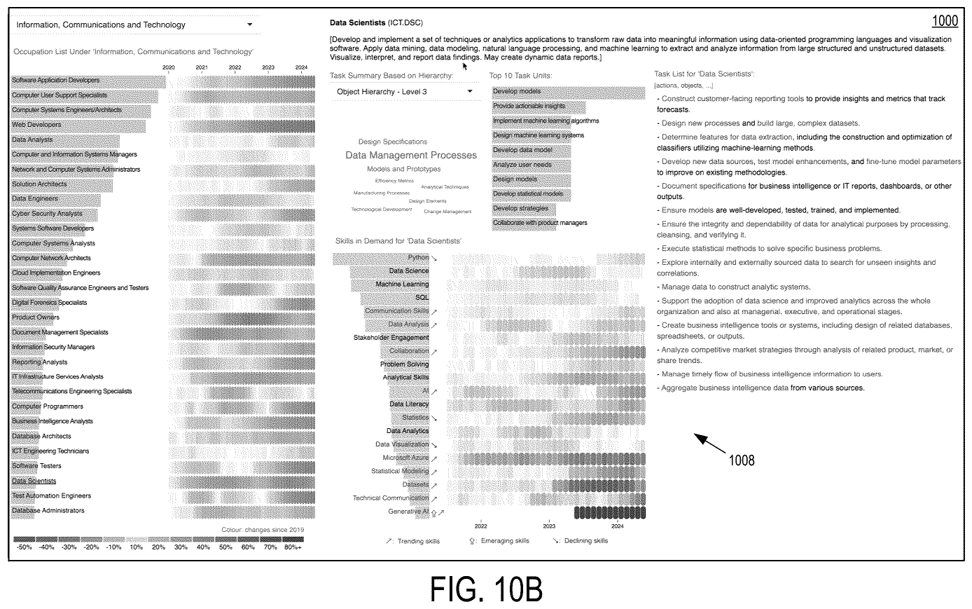

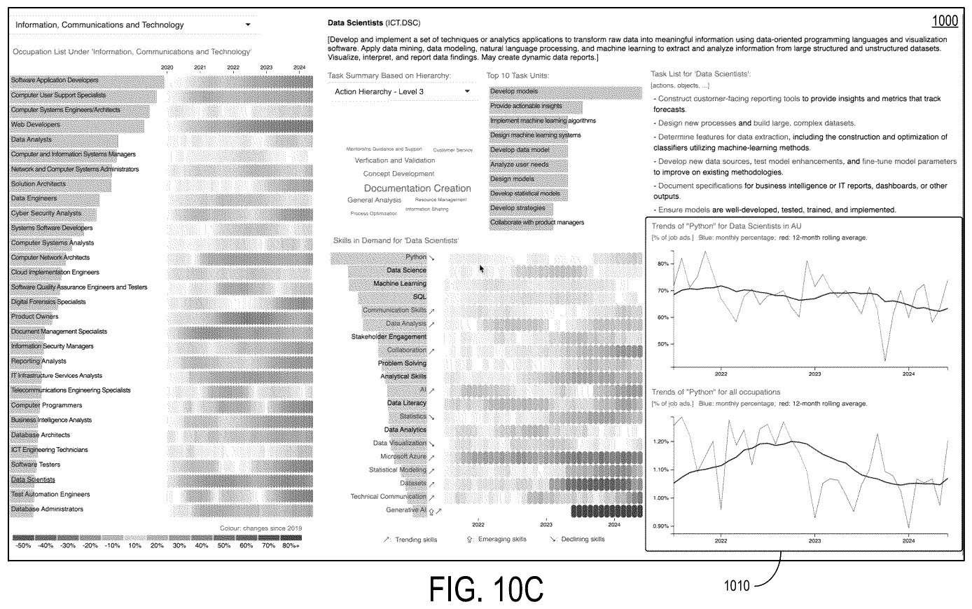

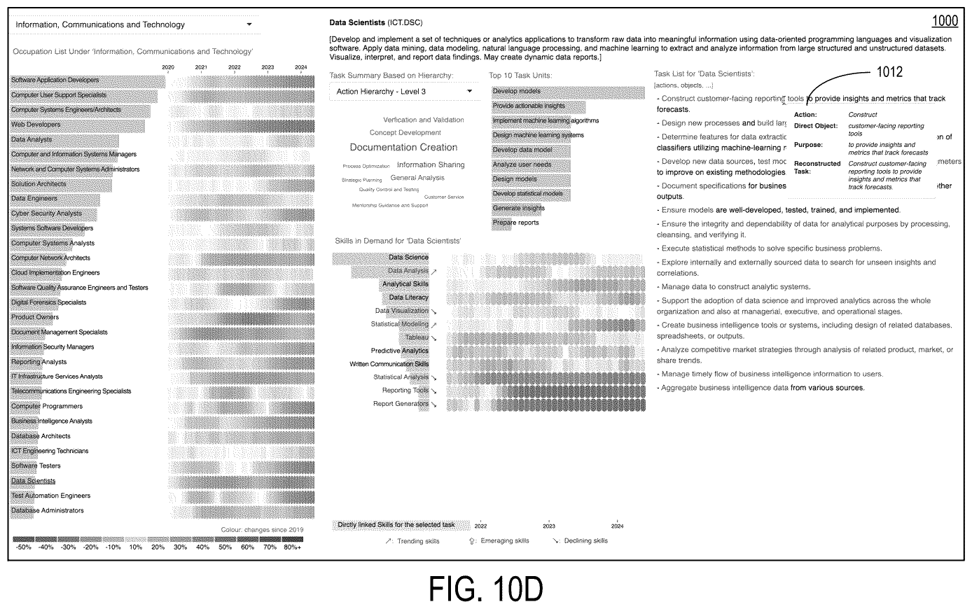

In some examples, the system 500 may interact with the client computing device(s) 206 via one or more communication networks 220. In some examples, the client computing device(s) 206 can include a GUI 616 to render and/or display environments 618 (e.g., dynamic video learning environments, text entry windows, etc.) for the user. In some examples, the GUI 616 may be generated in part by execution by the client computing device 206 of browser/client software 619 based on data received from the system 500 via the network 220. One example of the GUI 616 that may be generated and interacted with is shown and described further below with respect to FIGS. 10A-10D .

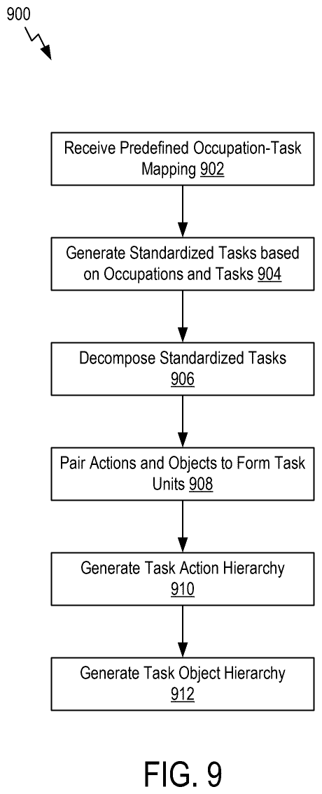

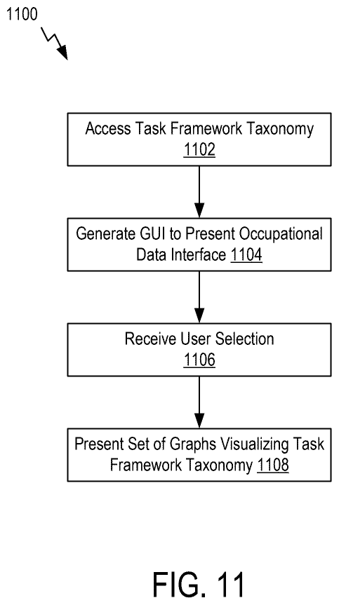

For example, the system 500 may be configured as a task framework modeling and/or presentation system. In such an implementation, the system 500 includes a memory (e.g., as one of the system components 204 and/or as part of the database 210) and a processor (e.g., as one of the system components 204) coupled with the memory. The processor may be configured to execute instructions stored in the memory or stored elsewhere, thereby to cause the system 500 to perform various operations. The operations may include any one or more of the operations described below, for example with regard to FIGS. 9 and 11. The processor may be said to “generate” the dynamic content if the processor itself creates the dynamic content (e.g., by running one or more engines associated with the generative AI model) or if the processor receives data from another source (e.g., from an external generative AI model) and creates a copy of the data in the memory. The data ingested or output by the system 500 may be in one or more file formats, including open-source and proprietary formats. The data may include plain text or rich text in one or more formatting languages, including TeX, LaTex, HyperText Markup Language (HTML), Javascript Object Notation (JSON), and the like. These operations are merely exemplary, and the system 500 may be configured to perform any of the operations illustrated in FIGS. 7-9 and/or 11, discussed in more detail below.

FIG. 7 illustrates one example task framework 700. The framework 700 may comprise four components: a component for standardizing tasks by deconstructing (also referred to as decomposing) them into action-object pairs, validated via reconstruction; a component for constructing a hierarchical task structure using LLMs; a component for mapping tasks to occupations for role-specific insights; and a component for linking tasks to skills through job ad analysis and LLMs. The overall framework 700 includes a standardized task taxonomy framework 710, and an action/object (A/O)-based task hierarchy framework 720, and an insights framework 730.

In the standardized task taxonomy framework 710, the task analysis and management procedure may begin with a preexisting occupation-task mapping 711. In one example, the mapping 711 builds on the O*NET task database, which is derived from survey data and human input. Tasks for occupations not covered by O*NET may be created by reviewing related O*NET tasks and consulting domain experts. However, both the O*NET database and the extended task ontology suffer from inconsistencies, with tasks varying in granularity and complexity. Complex task statements make it hard to identify the main outcomes and skills used, limiting their utility for analysis, insight generation, and workforce modeling.

The framework 710 may then proceed to task standardization 712. The standardization 712 may be performed through a series of steps using an LLM, such as GPT-4. In preparation for standardization, the task terminology may be updated to reflect modern practices. For example, “Enter tax return information into computers for processing” is revised to “Process tax return information,” aligning it with modern highly digitalized procedures. Next, similar tasks are consolidated to reduce redundancy and identify shared tasks across occupations. Using cosine similarity, task pairs with a similarity score above a threshold may be identified. The LLM reviews these pairs, and, for confirmed matches, it selects the most representative task as the standard. Concatenated tasks (i.e., statements that combine two independent tasks) are then separated into distinct standard tasks. For instance, “Collect samples, such as blood, urine, or sputum from patients, and perform routine laboratory tests on samples” is split into “Collect samples, such as blood, urine, or sputum from patients” and “Perform routine laboratory tests on samples.” Each standardized task now has a clearly distinguishable set of skills and outcomes. The quality of the standardized tasks is then evaluated, for example by calculating a ROUGE F1 score. The average ROUGE F1 score for the standardized tasks is 0.97, indicating that the standardized tasks closely align with the original task information.

After standardization 712, the tasks are subjected task decomposition and reconstruction. A task statement typically consists of actions, objects, and in some examples context (setting, situation), purpose (goal) and enablers (tools, skills, etc.). Following the task standardization 712 process, each standardized task is decomposed into its core components to enable more effective analysis and structured representations. Decomposition of tasks into actionable elements facilitates better understanding and insight generation. In the illustrated example, the decomposition separates the task into actions 713, objects 714, and other parts 715. These may generally be referred to as task units 716. The LLM may be used to identify all actions within each task statement, the direct objects these actions are applied to, and any indirect objects affected by the direct object. The model's responses are scored from 0 to 1 to improve performance and identify low-quality outputs. Additional prompts capture any actions or objects missed during the initial pass, particularly in complex task structures. Further LLM prompts extract the context, purpose, and enablers for each task, with responses also scored for quality. A follow-up prompt refines the classifications, ensuring each task excerpt is uniquely represented under a single component for every action-object pair. From these finalized components, simplified tasks are reconstructed by concatenating actions, objects, and context. The LLM validates the grammatical correctness and coherence of these reconstructed tasks. A ROUGE F1 score measures how well the reconstructed tasks represent the original standardized tasks. This systematic deconstruction clarifies the task focus, enabling analysis and the creation of a structured task hierarchy.

A single prompt or a simple series of prompts may not be effective to deconstruct and/or reconstruct the tasks. For example, such prompting may give poor results and include frequent misclassifications. Thus, the LLM may be invoked (e.g., prompted) at several points of the decomposition procedure by breaking the process into multiple steps (invocations), each with their own criteria. As noted above, for each invocation the LLM may self-critique its response and give itself a score from 0-1. Between each invocation, the outputs may also be checked to ensure that the extracted components match text in the original task to capture any hallucination. For example, the LLM may be invoked to identify and separate compound tasks (e.g., task descriptions that correspond to multiple tasks, for example by including words such as “and” or “or”) into simple tasks (e.g., task descriptions that correspond to a single task). The LLM may be invoked to separate the simple tasks into components, such as actions, context, purpose, objects, etc. This separation may involve multiple invocations of the LLM. The LLM may then be invoked to convert the separated components into action/object pairs and to confirm the decomposition. By invoking the LLM multiple times, the outputs may be more accurate than a single invocation that performs the multiple operations. Finally, the LLM may be invoked to check the grammar before outputting the reconstructed tasks.

In the A/O based task hierarchy framework 720, the standardized task unit set 716 (created from the decomposed task components) may be introduced to an action/object-based task hierarchy to systematically organize tasks into a structured, multi-level framework. This hierarchy enhances clarity, standardization, and analysis by uncovering task relationships and supporting workforce modeling.

A task unit represents the smallest, independent unit of work, defined by a single action and object. Initial task units 716 are generated from task decomposition outputs, with non-specific or meaningless entries such as “perform activity” or “used methods” filtered out by the LLM and reviewed by domain experts. Because the original tasks were derived from human inputs, the extracted task units often exhibit inconsistencies and duplicates. To standardize these task units, pairwise similarity may be calculated using a bi-encoder model to identify duplicates, which are removed based on a similarity threshold. The LLM then reviews and labels equivalent units, clusters similar entries, and selects the most representative description as the standard task unit 721. For example, “change policies,” “update policies,” and “modify existing policies” are unified as “update policies.” These standardized task units 721 form the foundation of the task hierarchy at its most granular level.

Actions 722, represented by verbs, define the behaviors within tasks and form the backbone of the task-action hierarchy 724. This hierarchy 724 highlights universal actions and their integration into complex workflows. The hierarchy 724 is built by identifying frequent actions from task decomposition. Using the LLM, these actions are clustered by semantic similarity, with clusters manually reviewed for accuracy. Fundamental, common actions form the top level, with related actions grouped as sub-actions beneath them. This process is iteratively refined to ensure precision and consistency. As a result, we define a three-level task-action hierarchy 724 is defined. A top-level category such as Analysis and Information Management is divided into Research and Data Gathering, Analysis and Interpretation, and the like. Research and Data Gathering is further split into Data Collection, and Exploration and Investigation, and the like

Objects 723 typically represented by nouns, are the focus of an action, answering the question: “to whom or what is the action directed?” Unlike actions 722, which tend to be finite and well-defined, objects 724 exhibit far greater diversity, making comprehensive hierarchy construction more challenging. The task-object hierarchy 725 is constructed starting with three broad categories at the top level: People, Data, and Physical Objects. The LLM classifies the objects 723 into these categories, and refines them into more specific subcategories, forming the second and third hierarchy levels. Semantic clustering and manual review ensure coherence, resulting in a structured framework that captures object diversity and their relationships across tasks.

Building on the frameworks 710 and 720, a robust job ads analysis pipeline is developed, referred to herein as an insights framework 730, to process large-scale data and extract actionable insights. The framework 730 may implement a Job Matcher model to classify job ads 733 into the occupation taxonomy 732 (e.g., following the structure of mapping 711); a Named Entity Recognition (NER) model for extracting task and skill entities; bi-and cross-encoder models for mapping extracted entities to the tasks and skills taxonomy 731; and an insight module to aggregate and analyze the task and skill data at the occupation level.

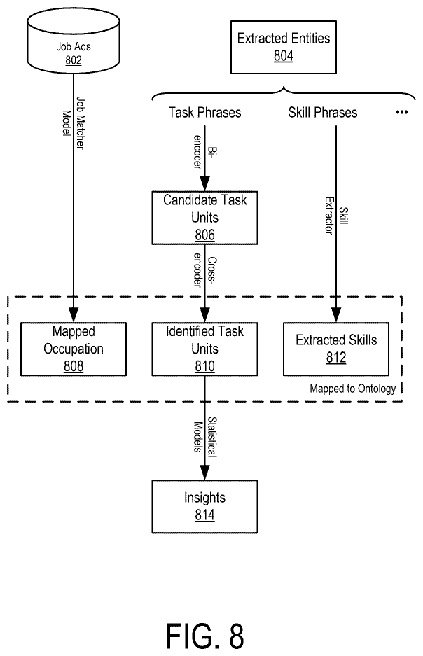

All models are fine-tuned from pre-trained language models, with training data prepared using LLMs and samples reviewed by domain experts to create high-quality golden datasets. For example, in developing the task bi-encoder and cross-encoder models, over 200 k task phrases from job ads were labeled with matched task units using GPT-4. Testing various pre-trained embeddings, all-mpnet-base-v2 was selected for the final model. The task bi-encoder achieves a top-20 match accuracy of 0.83, and the cross-encoder achieves 0.87 on the golden dataset. An average of 10 million job ads per month were analyzed using the pipeline, as illustrated in more detail in FIG. 8. The insights framework 730 aggregates and analyzes task and skill data by country at the occupation level, uncovering patterns and trends such as the top task units and skills required for each occupation, as well as trending, emerging, and declining skills per occupation.

In FIG. 8, data regarding job ads 802 is input into a job matcher model to produce a mapped occupation 808. Extracted entities 804 are also input to the system. The extracted entities 804 may include task phrases, skill phrases, and the like. The task phrases are input to the bi-encoder model to generate candidate task units 806, which in turn are input to the cross-encoder model to identify task units 810. The skill phrases may be input to a skill extractor to identify extracted skills 812. The mapped occupation 808, identified task units 810, and extracted skills 812 may then be mapped to the task taxonomy ontology. Statistical models may be applied to generate insights 814.

Returning to FIG. 7, building on the job ads analysis pipeline described above, tasks may be mapped to skills using a nominator-evaluator structure that ensures precise and contextually relevant mappings. The nominator identifies potential skills associated with tasks using several methods. In a keyword search method, the nominator performs exact keyword matching using predefined alternative skill names from the skills ontology to identify explicitly mentioned skills in task descriptions. This ensures precise linkages when skill names or synonyms appear directly in task descriptions. For example, for the task “Analyze the computed data using statistical software such as SA S or Python,” the identified skills may include Statistical Software, SAS and Python.

In a semantic match method, to capture implied skills, a semantic search employs a bi-encoder and cross-encoder architecture, computing contextual similarity between task descriptions and skills in the ontology. For example, skills including Business Reporting and Business Performance Management are identified for the task “Prepare reports on business unit performance.” In a task to top skills mapping method, top associated skills from job ads are identified for each operation. By combining this occupational skill data with task descriptions, the LLM is used to identify which top skills for the occupation are relevant to the task. This contextual approach bridges occupational expertise with task content. For example, for the task “Transplant seedlings, cuttings, trees, and shrubs” performed by Nursery Workers, identified skills include Horticulture, Plant Propagation, and General Labor. In a top skills to tasks mapping method, the inverse occurs. That is, top skills associated with an occupation are used to infer tasks supported by those skills. Prompts evaluate how each skill relates to various tasks within the occupational context, ensuring comprehensive task coverage. For example, for the occupation Dentists and the skill Dental Examinations, relevant tasks include “Analyze dental needs to determine changes in patterns of dental disease” and “Diagnose diseases or abnormalities related to dental health.”

The evaluator uses the LLM to classify skills from the nominators into three categories: Directly Linked Skills (essential for task completion), Supporting Skills (enhancing but not essential), and Irrelevant Skills (filtered out). This structured categorization refines the task-skill mappings, balancing precision and flexibility.

FIG. 9 illustrates one example implementation of the task framework ontology described above, including a method 900 for constructing a task framework for workforce analysis (also referred to herein as a “workforce task framework”). The method 900 may be implemented by any of the devices or systems described above. For example, the various operations of the method 900 may be performed by an electronic processor of any of the above devices or systems.

The method 900 includes an operation 902 of receiving a predefined occupation-task mapping (e.g., mapping 711 of FIG. 7). The occupation-task mapping may indicate a relationship between a plurality of raw occupations and a plurality of raw tasks. At operation 904, the contents of the occupation-task mapping may be provided to a first AI model (e.g., a first LLM), wherein the first AI model is configured to return a plurality of standardized tasks (e.g., tasks 712 of FIG. 7). The standardized tasks may be validated to determine a degree of alignment with the raw tasks. These standardized tasks, at operation 906, may be provided to a second AI model (e.g., a second LLM) , wherein the second A I model is configured to decompose the plurality of standardized tasks into at least a plurality of actions and a plurality of objects (e.g., the actions 713, objects 714, and other parts 715 of FIG. 7). In some implementations, the first and second AI models may be the same.

At operation 908, respective ones of the plurality of actions may be paired with respective ones of the plurality of objects to form a plurality of task units (e.g. task units 716 of FIG. 7). Each task unit may include an action-object pair. The task units may be used to generate a task action hierarchy (e.g., task action hierarchy 724 of FIG. 7) at operation 910 and a task object hierarchy (e.g., task object hierarchy 725 of FIG. 7) at operation 912. The task action hierarchy may indicate a set of actions corresponding to a given standardized task and may include a plurality of task action tiers (e.g., a top-level tier, a second level tier, and a lowest-level tier). The task object hierarchy may indicate a focus of the set of actions corresponding to the given standardized task and may include a plurality of task object tiers (e.g., a top-level tier, a second level tier, and a lowest-level tier). A task-skills mapping indicating at least one skill related to at least one task of a given occupation may also be generated, for example by applying a keyword search method, a semantic match method, a top-task-to-skills mapping method, or a top-skills-to-tasks mapping method as described above with regard to FIG. 8. The task-skills mapping may also indicate a timewise trend in the relationship between the skill(s) and the task(s). The generated task action hierarchy and task object hierarchy may be stored in a memory (e.g., a database) as the workforce task framework. The task-skills mapping may be stored in a memory (e.g., the same or a different database) as a job taxonomy.

The workforce task framework may be updated or maintained based on continuing job advertisement data, for example from a job advertisement database. In such examples, one or more job advertisements may be received and one or more tasks may be extracted therefrom. One or more encoder models may be applied to the extracted task to map the task to an entry in the task action hierarchy and the task object hierarchy originally generated at operations 910 and 912. The encoder models may be NLP encoder models, such as a bi-encoder model and/or a cross-encoder model (e.g., as illustrated in FIG. 8).

The operations of FIG. 9 may be performed in a different order than that illustrated, so long as an operation that requires the output of another operation occurs after the other operation. In some examples, various operations (e.g., operations 910 and 912) may be performed in parallel or in the opposite order as indicated.

The systems and methods set forth above may also be implemented with an interactive visualization system to present and permit interaction with the above task framework. The visualization system may be presented via a GUI that presents multiple coordinated visual presentations for interactive exploration. FIGS. 10A-10D illustrate various output states of a GUI 1000 corresponding to the results of operations by the system 500 and/or the performance of various operations of the methods described above The GUI 1000 is an example of the GUI 616 on the client(s) 206 illustrated and described with respect to FIG. 6.

FIG. 10A illustrates a first presentation portion of the GUI 1000. In the first presentation portion, an occupation trends panel 1002 is presented that offers an overview of the workforce landscape (e.g., as determined by the task framework described above). The panel 1002 allows a user to select occupation categories, such as Information, Communications and Technology in the illustrated example. A simplified bar chart integrated with a heatmap presents overall occupation trends for the selected occupation category. In the panel 1002, a bar is presented underlying an occupation name to indicate the relative percentage of job listings within the occupation category that correspond to the occupation. Next to the bar, the heatmap shows the relative changes in the number of listings for the occupation (e.g., relative to a reference date).

The panel 1002 may be configured to present detailed information based on a user selection of a particular occupation. For example, if the user mouses over a position 1004, a detailed trends panel 1006 may be presented showing a line chart for detailed trends. In the illustrated example, the panel 1006 shows both monthly data and a 12-month rolling average. If the user clicks the position 1004, an occupation-based insights and ontology view panel 1008 may be presented as shown in FIG. 10B. The occupation-based insights presented may include a bar chart (labeled “Top 10 Task Units” in FIG. 10B) showing the top task units and a heatmap (labeled “Skills in Demand for ‘Data Scientists’” in FIG. 10B) that visualizes detailed skill requirements for the selected occupation. Trending, emerging, and declining skills may be highlighted with colors and labels for emphasis. Mousing over a skill in the heatmap of panel 1008 may cause the GUI 1000 to present trends data for the selected skill as shown in FIG. 10C. In the illustrated example, the GUI 1000 displays a trends panel 1010 that includes two line charts respectively showing the trend of the skill for the selected occupation and across all occupations.

Returning to FIG. 10B, the panel 1008 may further display a word cloud summarizing actions or objects based on the A/O-based task hierarchy, with granularity adjusted via a selection box (labeled “Task Summary Based on Hierarchy” in FIG. 10B). This view also includes a detailed list of tasks associated with the selected occupation (labeled “Task List for ‘Data Scientists’” in FIG. 10B), with actions and objects highlighted in different colors. Mousing over a task from the task list causes the GUI 1000 to present a detailed decomposition panel 1012 (see FIG. 10D) that shows the corresponding task unit, A/O summary, and relevant skills to the selected task highlighted in other views.

FIG. 11 illustrates one example implementation of the task framework ontology described above, including a method 1100 for a presentation of the workforce task framework (e.g., as shown in FIGS. 10A-10D) . The method 1100 may be implemented by any of the devices or systems described above. For example, the various operations of the method 1100 may be performed by an electronic processor of any of the above devices or systems. In examples, the method 1100 may be performed by a user device. In other examples, the method 1100 may be performed by a server device and presented to the user (e.g., by transmitting data to the user device for presentation).

The method 1100 includes an operation 1102 of accessing the workforce task framework. The workforce task framework may be generated by the method 900 of FIG. 9, and may be stored in a database or may be directly accessed without storage (e.g., the method 1100 may be performed immediately following the method 900). In either case, the workforce task framework includes a task action hierarchy indicating a respective set of actions corresponding to one of a plurality of tasks, the task action hierarchy including a plurality of task action tiers, and a task object hierarchy indicating a respective focus of the respective set of actions corresponding to the one of the plurality of tasks, the task object hierarchy including a plurality of task object tiers (e.g., as shown in FIG. 7).

At operation 1104, a GUI is generated to present an occupational data interface (e.g., the GUI 1100) to the user. A user may perform a user selection operation via the GUI, which is then received at operation 1106. At operation 1108, a set of graphs is presented via the GUI to visualize a portion of the workforce task framework based on the user selection. The graphs may be in the form of a bar graph, a heatmap, a line graph, a word cloud, or combinations thereof. Additional information (e.g., lists, tables, etc.) may be presented alongside the graphs.

Operations 1106 and 1108 may correspond to those operations illustrated in FIGS. 10A-10D. Thus, for example, the user selection of operation 1106 may correspond to an occupation field selection indicating an occupation field (e.g., Information, Communications, and Technology as illustrated in FIG. 10A) . The occupation field may correspond to a top level of the taxonomy (e.g., a top level from among the task action tiers and/or a top level from among the task object tiers). In this example, the set of graphs may include a first graph indicating a relative prevalence of a plurality of occupations within the occupation field, and a plurality of second graphs respectively indicating a timewise trend in the relative prevalence of corresponding ones of the plurality of occupations. Thus, as shown in FIG. 10A, the visualization of operation 1108 may be presented in panel 1002 as a bar graph listing several occupations, and a set of heat maps for each occupation. Upon a further user selection (e.g., a mouseover of a set of heatmaps), a detailed graph may be presented to show trends in the occupation in more detail.

The user may additionally or alternatively perform an occupation selection at operation 1106 indicating an occupation corresponding to a second level of the taxonomy (e.g., a second level of the task action tiers and/or a second level of the task object tiers). In this example, the set of graphs may include a first graph indicating a relative prevalence of a plurality of skills relevant to the occupation in the workforce task framework, and a plurality of second graphs indicating a timewise trend in the relative prevalence of corresponding ones of the plurality of skills. Thus, as shown in FIG. 10B, the visualization of operation 1108 may be presented in panel 1008 as a bar graph listing several task units, a bar graph listing several skills, and a set of heatmaps for each skill. The visualization in this example further includes a word cloud and a task list for the selected occupation. If a user then selects a particular skill, further detail may be presented (e.g., as shown in FIG. 10C).

Additionally or alternatively, the user may perform a task selection at operation 1106 indicating an action and an object (e.g., a task unit) corresponding to a lowest level of the taxonomy (e.g., a lowest level of the task action tiers and/or a lowe3st level of the task object tiers). In this example, the first graph may indicate a relative prevalence of a plurality of tasks corresponding to an occupation and may highlight at least one task that corresponds to the task selection (e.g., as shown in FIG. 10D). The second graph may indicate a relative prevalence of a plurality of skills corresponding to the occupation and may highlight at least one skill corresponding to the task selection (e.g., as shown in FIG. 10D). Thus, as shown in the example of FIG. 10D, the first graph may be a bar graph and the second graph may include a bar graph and a set of heatmaps.

As noted above, the methods 900 and 1100, as well as operations and sub-operations thereof, may be implemented by various devices. For example, an electronic processor (e.g., of the system 500, the server(s) 202, or the client device(s) 206) may implement the method 900, the method 1100, operations of the methods 900 and/or 1100, and/or sub-operations of the methods 900 and 1100. Such an electronic processor may be, for example, implemented similar to the processing circuitry 504 described with respect to FIG. 5, and may include one or more processors, one or more processor cores, and/or one or more other processing elements, that are co-located, located separately from one another, or a combination thereof). As described with respect to the processing circuitry 504, to implement these and other functions, the electronic processor may retrieve and execute software and/or include particularly configured hardware.

Thus, the present disclosure encompasses both systems and methods for generating a workforce task framework and systems and methods for presenting the workforce task framework to a user and permitting the user to interact with (e.g., explore) the workforce task framework.

For example, the particular instance illustrated in FIGS. 10A-10D is based on a real-world scenario, where a recent Data Science graduate (the user) uses the visualization system to explore the job market and understand the task and skill requirements for different roles. The user may begin her exploration by checking occupation trends for different jobs in the market. She filters the data to focus on Information, Communications and Technology occupations and observes contrasting trends: roles like Software Application Developers and Web Developers have experienced high demand but are now declining; meanwhile, Cyber Security Analysts and Information reveals key objects such as models and prototypes, and data management processes. The skill requirements view shows that the most in-demand skills for Data Scientists include Python, Data Science, Machine Learning, and SQL. While skills like Python and Statistics shown declining demand, skills including Artificial Intelligence (AI) and Microsoft Azure are increasing. She also notices that Generative AI is labeled as “emerging.” Hovering over Python reveals two detailed line charts, one showing its demand trend for Data Scientists and the other across all applications, both indicating relative stability since early 2022.

In the task list view, the user examines detailed task descriptions with actions and objects highlighted in different colors for better context. Hovering over the task “Construct customer-facing reporting tools to provide insights and metrics that track forecasts” reveals its decomposition in a tooltip. This interaction also dynamically updates three views: (i) the word cloud highlights relevant action hierarchies like document creation and information sharing; (ii) generate insights and prepare reports are highlighted in the task unit view; and (iii) in the skills view, all the relevant skills for the selected task are listed, with directly linked skills highlighted in blue. These skills include Reporting Tools, Predictive Analysis, and Written Communication Skills. Thus, the user discovers that Machine Learning Engineers focus on developing models and algorithms, Data Analysts prioritize data analysis and reporting, and Data Engineers emphasize tasks like manage data integration and develop database architectures.

As such, the present disclosure may be implemented by different parties in different situations. An employer, employment service, or representative may leverage certain aspects of the present disclosure to construct a task framework that leverages AI for workforce analysis, planning, and management. This approach involves the decomposition and reconstruction of tasks into a hierarchical structure based on action-object pairings, systematically refined. The hierarchical structure may be supplemented (e.g., on an ongoing basis) with occupation and skill linkages from job advertisements, ensuring alignment with real-world workforce dynamics.

A job seeker, researcher, or other party may leverage certain aspects of the present disclosure to interact with the task framework, for example through a visual analytics system that enables interactive exploration and analysis of tasks, occupations, and associated skills. Thus, the present disclosure permits effective workforce analysis from all parties involved in the employment process.

Other examples and uses of the disclosed technology will be apparent to those having ordinary skill in the art upon consideration of the specification and practice of the invention disclosed herein. The specification and examples given should be considered exemplary only, and it is contemplated that the appended claims will cover any other such aspects or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its aspects.

1. A method for constructing a workforce task framework, the method comprising:
receiving, by an electronic processor, a predefined occupation-task mapping, wherein the occupation-task mapping indicates a relationship between a plurality of raw occupations and a plurality of raw tasks;
providing, by the electronic processor, the plurality of raw occupations and the plurality of raw tasks to a first artificial intelligence (AI) model, wherein the first AI model is configured to return a plurality of standardized tasks;
providing, by the electronic processor, the plurality of standardized tasks to a second AI model, wherein the second AI model is configured to decompose the plurality of standardized tasks into at least a plurality of actions and a plurality of objects;
pairing, by the electronic processor, respective ones of the plurality of actions with respective ones of the plurality of objects to form a plurality of task units;
providing, by the electronic processor, the plurality of task units to a third AI model, wherein the third AI model is configured to return a plurality of standardized task unit;
generating, by the electronic processor from the plurality of standardized task units, a task action hierarchy, wherein the task action hierarchy indicates a set of actions corresponding to a given standardized task and includes a plurality of task action tiers; and
generating, by the electronic processor from the plurality of standardized task units, a task object hierarchy, wherein the task object hierarchy indicates a focus of the set of actions corresponding to the given standardized task and includes a plurality of task object tiers.

2. The method of claim 1, further comprising validating the plurality of standardized tasks to determine a degree of alignment with the plurality of raw tasks.

3. The method of claim 1, wherein at least two of the first AI model, the second AI model, or the third AI model are the same AI model.

4. The method of claim 1, wherein the first AI model and the second AI model are large language models.

5. The method of claim 1, further comprising:
receiving, by the electronic processor from a job advertisement database, a job advertisement;
extracting, by the electronic processor, an advertisement task from the job advertisement; and
applying, by the electronic processor, at least one natural language processing (NLP) encoder model to the advertisement task to map the advertisement task to at least one of the plurality of standardized task units.

6. The method of claim 5, wherein the at least one NLP encoder model includes at least one of a bi-encoder model and a cross-encoder model.

7. The method of claim 1, further comprising generating, by the electronic processor, a task-skills mapping, wherein the task-skills mapping indicates at least one skill related to at least one task of a given occupation.

8. The method of claim 7, wherein the task-skills mapping further indicates a timewise trend in the relationship between the at least one skill and the at least one task.

9. The method of claim 7, wherein generating the task-skills mapping includes determining a plurality of potential skills using at least one of a keyword search method, a semantic match method, a task-to-skills mapping method, or a skills-to-tasks mapping method.

10. The method of claim 7, further comprising constructing, by the electronic processor, a job taxonomy database including the task-skills mapping.

11. A method of presenting a visualization of a workforce task framework, the method comprising:
accessing, by an electronic processor, the workforce task framework stored in a database, wherein the workforce task framework includes:
a task action hierarchy indicating a respective set of actions corresponding to one of a plurality of tasks, the task action hierarchy including a plurality of task action tiers, and
a task object hierarchy indicating a respective focus of the respective set of actions corresponding to the one of the plurality of tasks, the task object hierarchy including a plurality of task object tiers;
generating, by the electronic processor, a graphical user interface (GUI) for presenting an occupational data interface to a user;
receiving, by the electronic processor, a user selection via the GUI; and
presenting, by the electronic processor, a set of graphs via the GUI, the set of graphs visualizing a portion of the workforce task framework based on the user selection.

12. The method of claim 11, wherein the set of graphs includes at least one of a bar graph, a heatmap, a line graph, or a word cloud.

13. The method of claim 11, wherein the user selection corresponds to an occupation field selection, wherein the occupation field selection indicates an occupation field corresponding to at least one of a top level of the task action tiers or a top level of the task object tiers.

14. The method of claim 13, wherein the set of graphs includes:
a first graph indicating a relative prevalence of a plurality of occupations within the occupation field in the workforce task framework, and
a plurality of second graphs, wherein respective ones of the plurality of second graphs indicate a timewise trend in the relative prevalence of corresponding ones of the plurality of occupations.

15. The method of claim 11, wherein the user selection corresponds to an occupation selection, wherein the occupation selection indicates an occupation corresponding to at least one of a second level of the task action tiers or a second level of the task object tiers.

16. The method of claim 15, wherein the set of graphs includes:
a first graph indicating a relative prevalence of a plurality of skills relevant to the occupation in the workforce task framework, and
a plurality of second graphs, wherein respective ones of the plurality of second graphs indicate a timewise trend in the relative prevalence of corresponding ones of the plurality of skills.

17. The method of claim 11, wherein the user selection corresponds to a task selection, wherein the task selection indicates an action and an object corresponding to at least one of a lowest level of the task action tiers or a lowest level of the task object tiers.

18. The method of claim 17, wherein the set of graphs includes:
a first graph indicating a relative prevalence of a plurality of tasks corresponding to an occupation, the first graph highlighting at least one task of the plurality of tasks corresponding to the task selection; and
a second graph indicating a relative prevalence of a plurality of skills corresponding to the occupation, the second graph highlighting at least one skill corresponding to the task selection.

19. The method of claim 11, wherein the workforce task framework is generated by at least one artificial intelligence (AI) model configured to receive raw occupational data and return standardized occupational data.

20. The method of claim 11, wherein the workforce task framework is generated by at least one artificial intelligence (AI) model configured to receive standardized occupational data and return a decomposition of the standardized occupational data into a plurality of tasks and a plurality of objects, the plurality of tasks and the plurality of objects forming the basis of the plurality of task action tiers and the plurality of task object tiers.
